(19) United States
(12) Patent Application Publication
(10) Pub. No.: US 2025/0354512 A1
(43) Pub. Date: Nov. 20, 2025

(54) AFTERTREATMENT SYSTEM INCLUDING MIXER WITH EXHAUST SAMPLING FLANGE

(71) Applicant: CUMMINS EMISSION SOLUTIONS INC., Columbus, IN (US)

(72) Inventors: Chetan Kishorrao Chawane, Pune (IN); Tushar Sudam Udhane, Pune (IN); Atul N. Bamane, Raigad (IN); Anshul Chourasiya, Rajasthan (IN); Randolph G. Zoran, McFarland, WI (US); Jim L. Alonzo, Verona, WI (US)

(73) Assignee: CUMMINS EMISSION SOLUTIONS INC., Columbus, IN (US)

(21) Appl. No.: 19/288,331

(22) Filed: Aug. 1, 2025

Related U.S. Application Data
(63) Continuation of application No. PCT/US2024/014018, filed on Feb. 1, 2024.
(60) Provisional application No. 63/443,168, filed on Feb. 3, 2023.

(51) Int. Cl. F01N 3/28; B01D 53/94; B01F 25/314; B01F 25/431; B01F 35/21; B01F 101/00; F01N 3/20; F01N 11/00

(52) U.S. Cl. CPC F01N 3/2892; B01D 53/9431; B01F 25/3141; B01F 25/43197; B01F 35/2132; F01N 3/2066; F01N 11/00; B01D 2257/404; B01D 2258/012; B01F 2101/503; F01N 2610/03; F01N 2610/1453; F01N 2900/1402

(57) ABSTRACT

An aftertreatment system includes an introduction conduit and a mixer disposed within the introduction conduit. The introduction conduit is centered on a mixer body center axis. The mixer includes a mixer body, an exhaust sampling flange, an outlet flange, and an outlet tube. The exhaust sampling flange is coupled to the mixer body at a location adjacent to a second end of the mixer body. The exhaust sampling flange includes exhaust sampling flange apertures arranged in an array that extends circumferentially around the mixer body center axis. The outlet flange is coupled to the second end downstream of the exhaust sampling flange. The outlet flange includes an outlet flange aperture. The outlet tube is coupled to the outlet flange. The outlet tube is in fluid communication with at least one of the exhaust sampling flange apertures. The outlet tube extends over a portion of the outlet flange aperture.

### CROSS-REFERENCE TO RELATED APPLICATIONS

The present application is a bypass continuation of PCT/US2024/014018, filed Feb. 1, 2024, which claims priority to and the benefit of U.S. Provisional Patent Application No. 63/443,168, filed Feb. 3, 2023. The entire disclosures of these applications are hereby incorporated by reference herein.

### TECHNICAL FIELD

The present disclosure relates generally to an aftertreatment system for an internal combustion engine.

### BACKGROUND

For internal combustion engines, such as diesel engines, nitrogen oxide (NOₓ) compounds may be emitted in exhaust. It is desirable to reduce NOₓ emissions to comply with environmental regulations, for example. To reduce NOₓ emissions, a reductant may be dosed into the exhaust by a dosing system and within an aftertreatment system. The reductant facilitates conversion of a portion of the exhaust into non-NOₓ emissions, such as nitrogen (N₂), carbon dioxide (CO₂), and water (H₂O), thereby reducing NOₓ emissions.

In some applications, it may be desirable to sample a concentration of a constituent, such as NOₓ, N₂, CO₂, and/or H₂O, in the exhaust produced by an internal combustion engine and subsequently treated by an aftertreatment system. By sampling the concentration of the constituent, operation of the aftertreatment system can be monitored. Such sampling may be obtained using a sensor around which the exhaust is provided.

While existing methods of monitoring constituents of the exhaust using the sensor have generally been adequate, certain flow conditions may negatively impact the sampling results and, thus, the overall performance of the aftertreatment system. For example, with respect to sampling the exhaust upstream of a hydrocarbon mixer in the aftertreatment system at low-flow boundary conditions (e.g., velocity of the flow at or below 1 mL/s), particles of hydrocarbon fluid to be injected into the hydrocarbon mixer may exhibit higher momentum than the exhaust. Consequently, such particles may escape the hydrocarbon mixer, penetrate the flow of the exhaust, and be sampled by the sensor, which has cross-sensitivity toward certain particles of the hydrocarbon fluid. In addition, a sampling wheel (e.g., a NOₓ wheel) has been utilized for sampling the exhaust but such component may increase an axial length of the aftertreatment system, which may negatively impact the design and utility of components (e.g., the hydrocarbon mixer) of the aftertreatment system.

### SUMMARY

In one embodiment, an aftertreatment system includes an introduction conduit and a mixer disposed within the introduction conduit. The mixer includes a mixer body, an exhaust sampling flange, an outlet flange, and an outlet tube. The mixer body is centered on a mixer body center axis and configured to receive exhaust and a hydrocarbon fluid. The mixer body includes a first end and a second end downstream of the first end. The exhaust sampling flange is coupled to the mixer body at a location adjacent to the second end. The exhaust sampling flange includes exhaust sampling flange apertures arranged in an array that extends circumferentially around the mixer body center axis. The outlet flange is coupled to the second end at a location downstream of the exhaust sampling flange. The outlet flange includes an outlet flange aperture configured to facilitate flow of the exhaust from inside the mixer body. The outlet tube is coupled to the outlet flange. The outlet tube is in fluid communication with at least one of the exhaust sampling flange apertures. The outlet tube includes a first portion that is coupled to the outlet flange and a second portion that extends from the first portion and into the outlet flange aperture.

In another embodiment, a mixer for an aftertreatment system includes a mixer body, an injector plate, an exhaust sampling flange, an outlet flange, and an outlet tube. The mixer body is centered on a mixer body center axis and configured to receive exhaust and a hydrocarbon fluid. The mixer body includes an upstream end, a downstream end, and a first aperture between the upstream end and the downstream end. The injector plate is coupled to the mixer body adjacent the first aperture. The exhaust sampling flange is coupled to the mixer body between the first aperture and the downstream end. The exhaust sampling flange includes exhaust sampling flange apertures arranged circumferentially around the mixer body center axis. The injector plate is offset from a first of the exhaust sampling flange apertures along the mixer body center axis. The outlet flange is coupled to the downstream end at a location downstream of the exhaust sampling flange. The outlet tube is coupled to the outlet flange and in fluid communication with at least one of the exhaust sampling flange apertures. The outlet flange includes an opening configured to facilitate a flow of the exhaust between one of the exhaust sampling flange apertures and the outlet tube.

In yet another embodiment, an aftertreatment system includes an introduction conduit and a mixer disposed within the introduction conduit. The mixer includes a mixer body, an exhaust sampling flange, and an outlet flange. The mixer body is centered on a mixer body center axis and configured to receive exhaust and a hydrocarbon fluid. The mixer body includes a first end and a second end downstream of the first end. The exhaust sampling flange is coupled to the mixer body at a location between the first end and the second end. The exhaust sampling flange includes exhaust sampling flange apertures and a louver adjacent a first of the exhaust sampling flange apertures. The exhaust sampling flange apertures are arranged in an array that extends circumferentially around the mixer body center axis. The louver is angled away from the exhaust sampling flange and extends over at least a portion of the first exhaust sampling flange aperture in a rotational direction around the mixer body center axis. The outlet flange is coupled to the second end at a location downstream of the exhaust sampling flange. The outlet flange includes an outlet flange aperture configured to facilitate flow of the exhaust from inside the mixer body.

### BRIEF DESCRIPTION OF THE DRAWINGS

The disclosure will become more fully understood from the following detailed description, taken in conjunction with the accompanying Figures, wherein like reference numerals refer to like elements unless otherwise indicated, in which:

FIG. 1 is a cross-sectional view of a portion of an example aftertreatment system;

FIG. 2 is a perspective view of a portion of an example aftertreatment system;

FIG. 3 is a cross-sectional view of a portion the aftertreatment system of FIG. 2 taken along plane A-A in FIG. 2;

FIG. 4 is a perspective partial-transparency view of a portion of the aftertreatment system of FIG. 1 or FIG. 2;

FIG. 5 is a perspective exploded view of a portion of the aftertreatment system of FIG. 1 or FIG. 2;

FIG. 6 is a cross-sectional view of a portion of the aftertreatment system of FIG. 5 taken along plane B-B in FIG. 5;

FIG. 7 is a perspective view of the portion of the aftertreatment system of FIG. 6, according to one embodiment;

FIG. 8 is a perspective view of the aftertreatment system of FIG. 6, according to another embodiment;

FIG. 9 is a perspective view of a portion of the aftertreatment system of FIG. 5;

FIG. 10 is a perspective view of the aftertreatment system of FIG. 9;

FIG. 11 is an end view of a portion of the aftertreatment system of FIG. 5 from a downstream perspective;

FIG. 12 is a perspective view of a portion of the aftertreatment system of FIG. 5;

FIG. 13 is a detailed view of DETAIL A in FIG. 12;

FIG. 14 is a detailed, front view of DETAIL B in FIG. 13;

FIG. 15 is a cross-sectional view of a portion of the aftertreatment system of FIG. 9 taken along a plane C-C;

FIG. 16 is a perspective view of a portion of the aftertreatment system of FIG. 1 or FIG. 2;

FIG. 17 is perspective view of the aftertreatment system of FIG. 16;

FIG. 18 is a perspective side view of the aftertreatment system of FIG. 16;

FIG. 19 is a perspective view of a portion of the aftertreatment system of FIG. 16;

FIG. 20 is a detailed view of a perspective view of DETAIL C in FIG. 19;

FIG. 21 is a detailed view of DETAIL D in FIG. 20;

FIG. 22 is a detailed view of a perspective view of DETAIL E in FIG. 20;

FIG. 23 is a detailed view of a perspective view of DETAIL E in FIG. 20;

FIG. 24 is a detailed, front view of DETAIL F in FIG. 20;

FIG. 25 is a cross-sectional view of a portion of the aftertreatment system of FIG. 16 taken along a plane D-D;

FIG. 26 is an end view of the aftertreatment system of FIG. 16 from an upstream perspective;

FIG. 27 is a perspective view of a portion of the aftertreatment system of FIG. 1 or FIG. 2;

FIG. 28 is a perspective view of the aftertreatment system of FIG. 27;

FIG. 29 is a perspective side view of the aftertreatment system of FIG. 27;

FIG. 30 is a perspective view of the aftertreatment system of FIG. 27;

FIG. 31 is a perspective view of a portion of the aftertreatment system of FIG. 27; and

FIG. 32 is an end view of the aftertreatment system of FIG. 27 from an upstream perspective.

It will be recognized that the Figures are schematic representations for purposes of illustration. The Figures are provided for the purpose of illustrating one or more implementations with the explicit understanding that the Figures will not be used to limit the scope or the meaning of the claims.

### DETAILED DESCRIPTION

Following below are more detailed descriptions of various concepts related to, and implementations of, methods, apparatuses, and for treating exhaust of an internal combustion engine with an aftertreatment system (or simply “aftertreatment system”). The various concepts introduced above and discussed in greater detail below may be implemented in any of a number of ways, as the described concepts are not limited to any particular manner of implementation. Examples of specific implementations and applications are provided primarily for illustrative purposes.

### I. OVERVIEW

In existing implementations, exhaust produced by an internal combustion engines may be provided to a sensor (e.g., a NOₓ sensor) via a sampling wheel (e.g., a NOₓ wheel) positioned between a catalyst member (e.g., a selective catalyst reductant member) and a hydrocarbon mixer. The sensor may be coupled to the sampling wheel. Under certain flow conditions, results of the sampling may be inaccurate due to cross-sensitivity of the sensor to components of the hydrocarbon fluid that escape from the hydrocarbon mixer. Being positioned upstream of the hydrocarbon mixer may cause the sampling wheel to introduce additional backpressure to the aftertreatment system and potentially disrupt the mixing of the exhaust and a hydrocarbon fluid by the hydrocarbon mixer. Furthermore, such arrangement of the sampling wheel may introduce unnecessary and undesirable axial length to the configuration of the aftertreatment system.

To address these and other challenges, an aftertreatment system is described herein that includes an exhaust sampling flange coupled to a mixer (e.g., a hydrocarbon mixer), which is disposed within an introduction conduit. The mixer includes at least a mixer body, an exhaust sampling flange, an outlet flange, and an outlet tube. The mixer body is centered on a mixer body center axis and configured to receive exhaust and a hydrocarbon fluid. The mixer body includes a first end and a second end downstream of the first end. The exhaust sampling flange is coupled to the mixer body at a location adjacent to the second end but upstream of the outlet flange. The exhaust sampling flange is positioned downstream of an injection aperture through which a hydrocarbon fluid is provided to be mixed with the exhaust in the mixer body.

The exhaust sampling flange includes exhaust sampling flange apertures arranged in an array that extends circumferentially around the mixer body center axis. The exhaust sampling flange apertures provide openings through which portions of the exhaust downstream of an upstream catalyst member is provided for sampling by a sensor (e.g., a NOₓ sensor configured to measure a signal associated with an amount of NOₓ in the exhaust), which is coupled to the mixer body between the exhaust sampling flange and the outlet flange along the mixer body center axis.

In some embodiments, the exhaust sampling flange apertures are open and circular (e.g., perforations). In some embodiments, the exhaust sampling flange includes louvers each having a louver panel that extends over at least a portion of a corresponding exhaust sampling flange aperture. Each louver panel is angle away from the exhaust sampling flange in a rotational direction (e.g., clockwise or counterclockwise) configured to increase the velocity and the swirling of the flow of the exhaust provided through the exhaust sampling flange apertures.

The outlet flange is coupled to the second end at a location downstream of the exhaust sampling flange. The outlet flange includes an outlet flange aperture configured to facilitate the flow of the exhaust from inside the mixer body. The outlet flange further includes an opening configured to facilitate the flow of the exhaust between one of the exhaust samplings flange apertures and the outlet tube. The outlet tube is coupled to the outlet flange and in fluid communication with at least one of the exhaust sampling flange apertures. The outlet tube extends over a portion of the outlet flange aperture along an axis perpendicular to the mixer body center axis. The opening on the outlet flange and the outlet tube are configured such that a pressure differential across the opening draws the flow of the exhaust across the sensor into the downstream components of the aftertreatment system through the outlet tube at an increased velocity.

By adjusting the configuration and distribution of the exhaust sampling flange apertures, the velocity, distribution, and/or swirling of the flow of the exhaust through the exhaust sampling flange apertures may be enhanced to allow sampling at low-flow boundary conditions with reduced interference from potential contamination by the hydrocarbon fluid. In this regard, cross-sensitivity of the sensor to particles of the hydrocarbon fluid may be mitigated. Additionally, by coupling both the sensor and the exhaust sampling flange to the mixer body, an axial length (e.g., along the mixer body center axis) of the aftertreatment system may be reduced to achieve a more compact design for the aftertreatment system.

### II. OVERVIEW OF EXAMPLE AFTERTREATMENT SYSTEMS

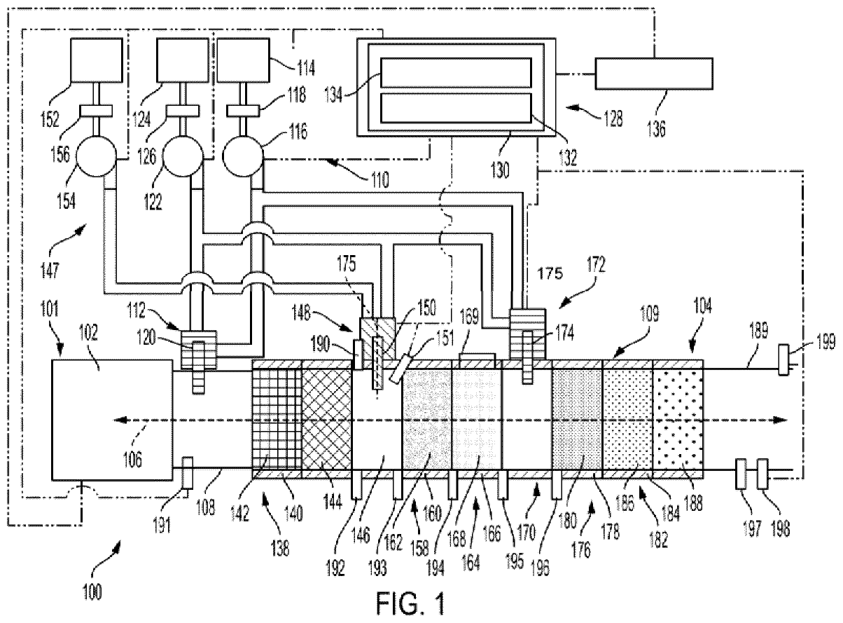

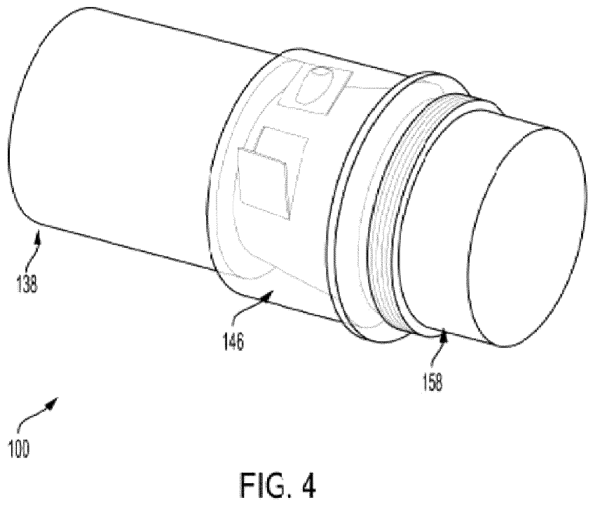

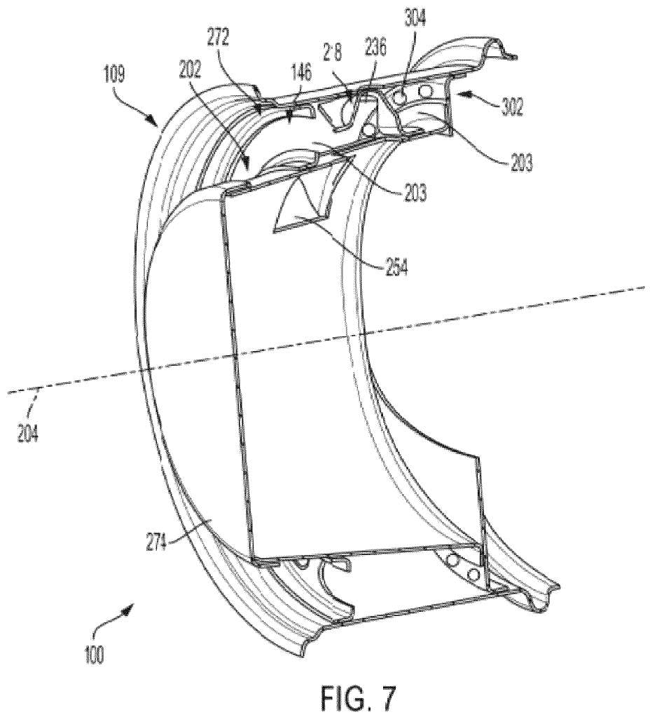

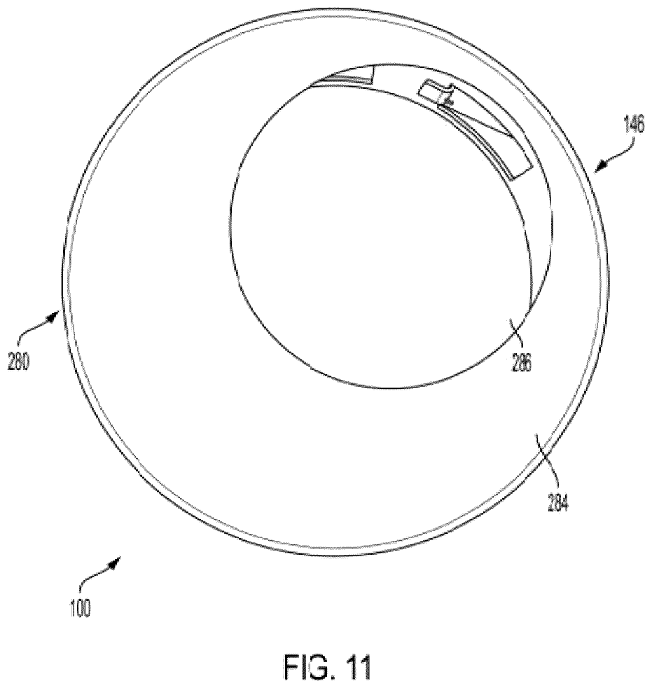

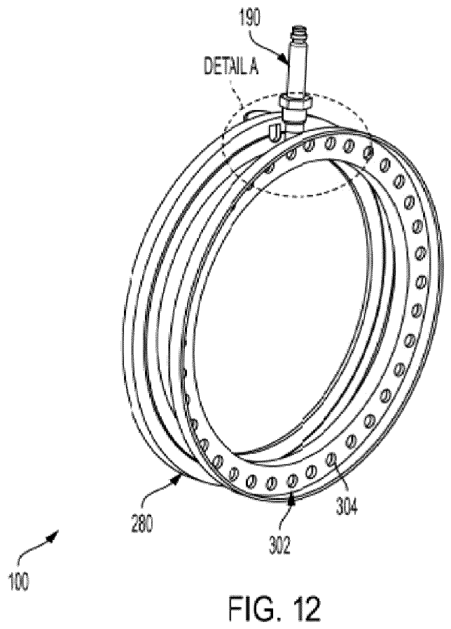

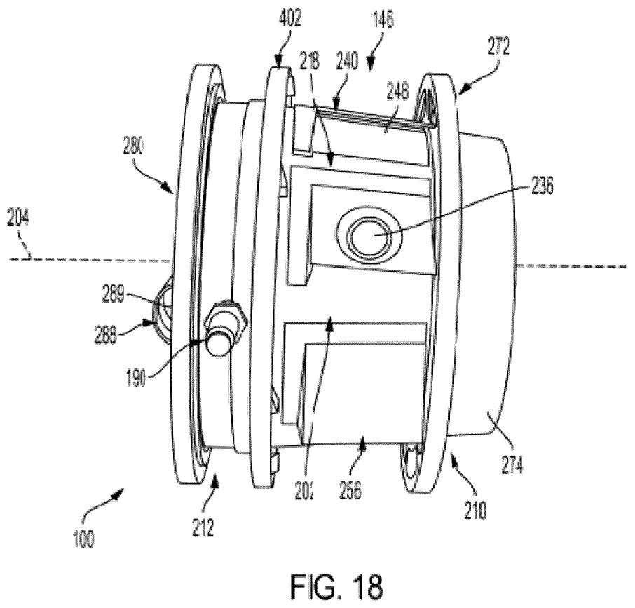

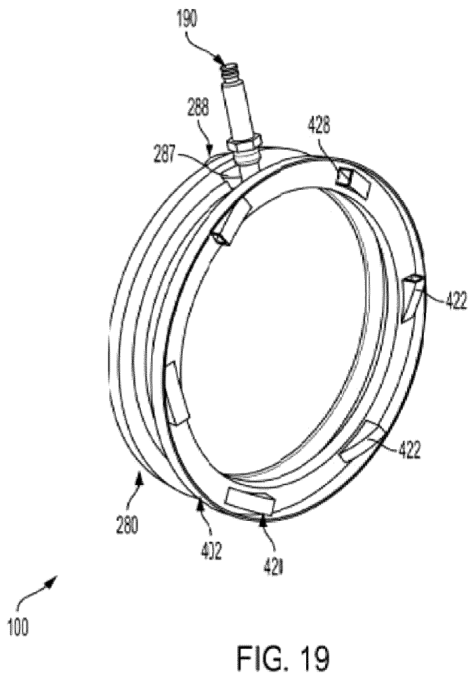

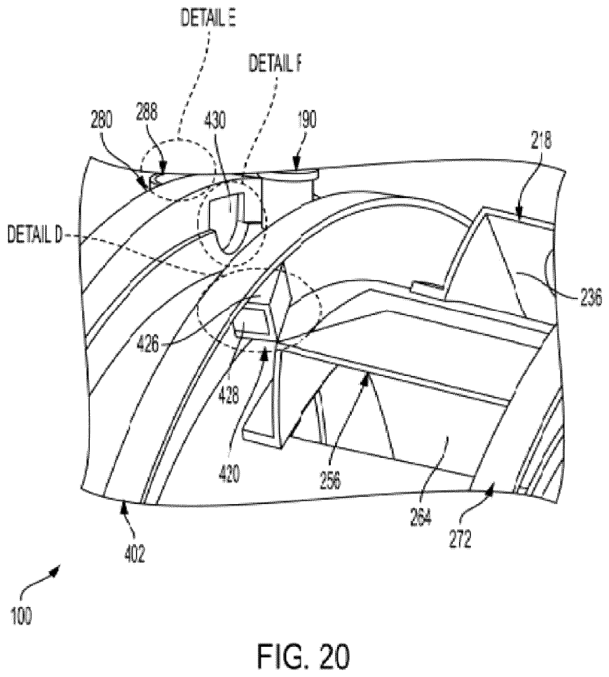

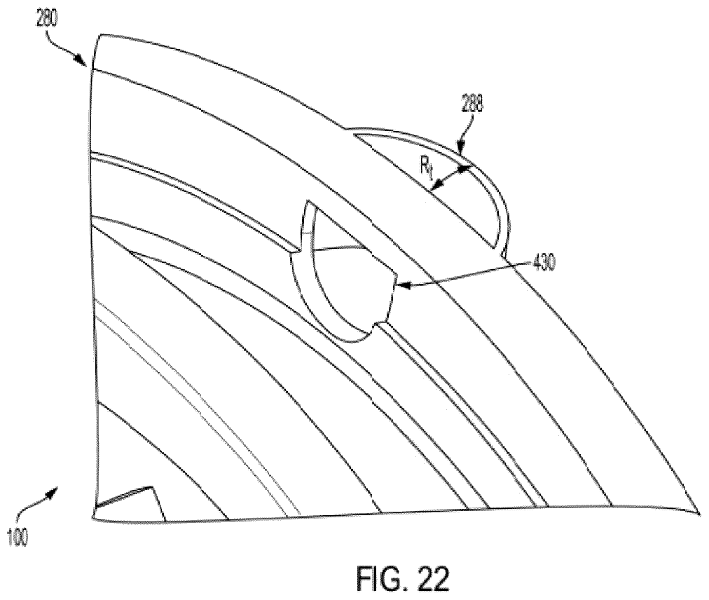

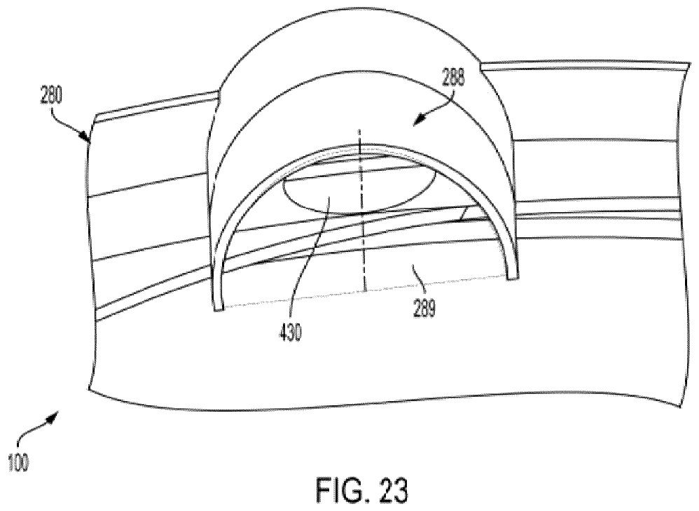

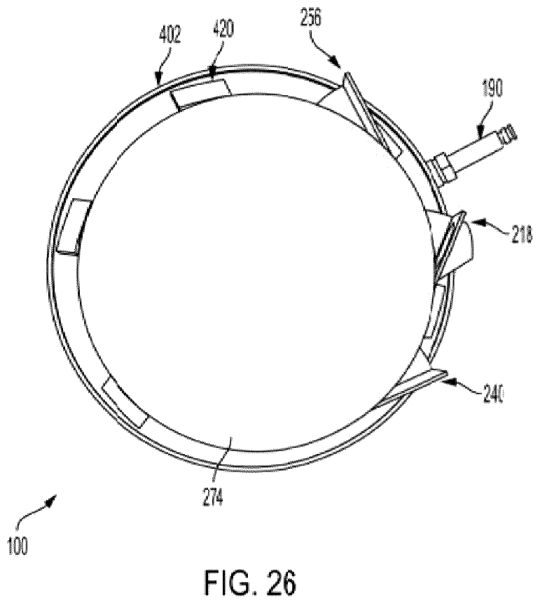

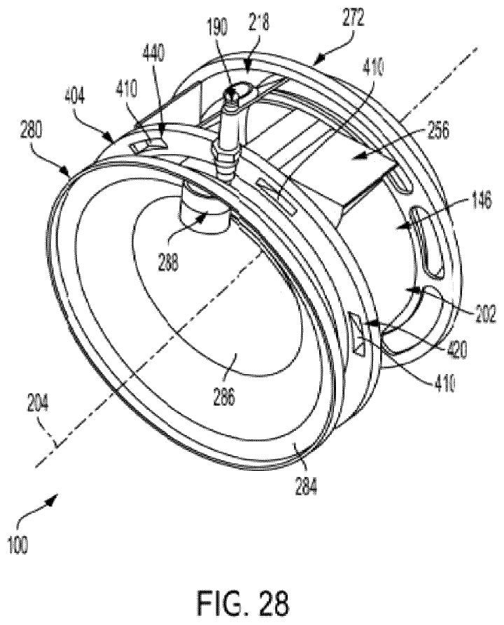

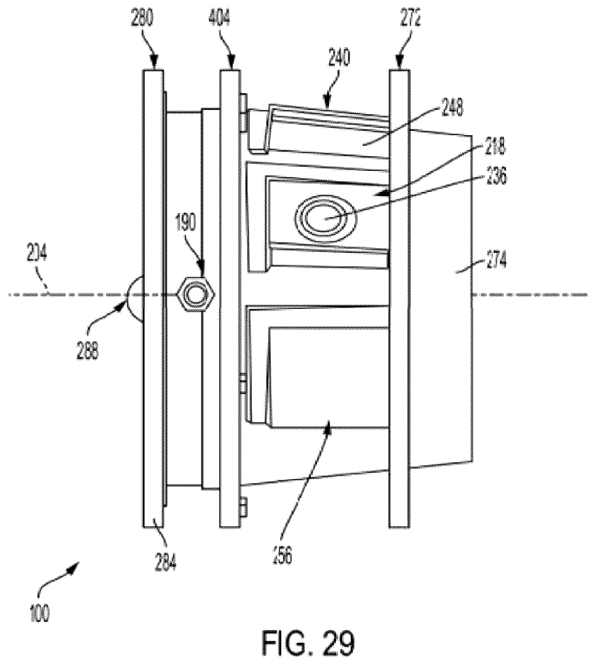

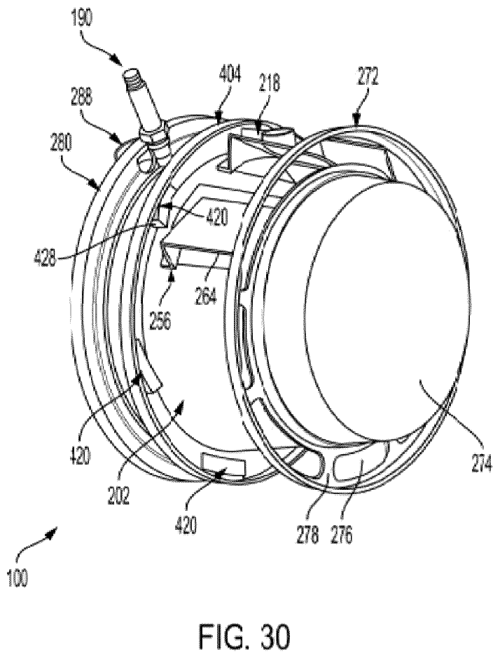

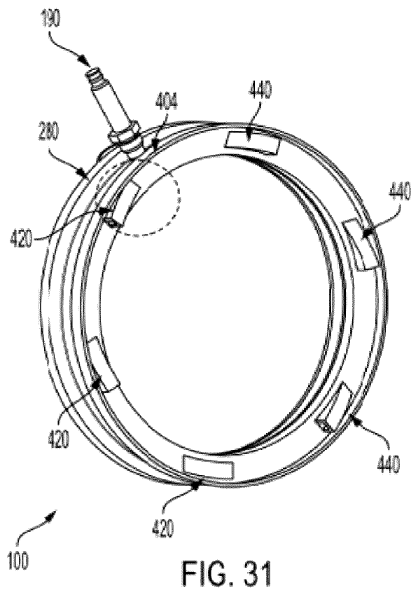

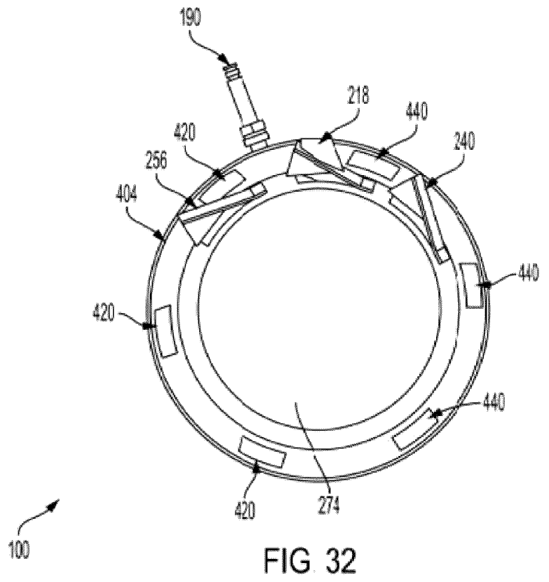

FIG. 1-32 depict an aftertreatment system 100 (e.g., treatment system, etc.) for an internal combustion engine system 101. The internal combustion engine system 101 includes an internal combustion engine (e.g., diesel internal combustion engine, gasoline internal combustion engine, hybrid internal combustion engine, propane internal combustion engine, dual-fuel internal combustion engine, etc.). The internal combustion engine system 101 includes a turbocharger 102. The aftertreatment system 100 is configured to treat exhaust produced by the internal combustion engine. As is explained in more detail herein, the aftertreatment system 100 is configured to facilitate treatment of the exhaust. The treatment may facilitate reduction of emission of undesirable components (e.g., nitrogen oxides (NOₓ), sulfur oxides (SOₓ), etc.) in the exhaust. The treatment may also or instead facilitate conversion of various oxidation components (e.g., carbon monoxide (CO), hydrocarbons (HC), etc.) of the exhaust into other components (e.g., CO₂, water vapor, etc.). The treatment may additionally or alternatively facilitate removal of particulates (e.g., soot, particulate matter, etc.) from the exhaust.

The aftertreatment system 100 includes an exhaust conduit system 104 (e.g., line system, pipe system, etc.). The exhaust conduit system 104 is configured to facilitate routing of the exhaust produced by the internal combustion engine throughout the aftertreatment system 100 and to atmosphere (e.g., ambient environment, etc.). The exhaust conduit system 104 is centered on a conduit axis 106 (e.g., the conduit axis 106 extends through a center point of the exhaust conduit system 104, etc.). As used herein, the term “axis” describes a theoretical line extending through the centroid (e.g., center of mass, etc.) of an object. The object is not necessarily cylindrical (e.g., a non-cylindrical shape may be centered on an axis, etc.), as depicted herein.

The exhaust conduit system 104 includes an intake chamber 108 (e.g., line, pipe, etc.). The intake chamber 108 is configured to receive exhaust from the internal combustion engine. The intake chamber 108 may receive exhaust from a portion of the internal combustion engine (e.g., header on the internal combustion engine, exhaust manifold on the internal combustion engine, the internal combustion engine, etc.). In some embodiments, the intake chamber 108 is coupled (e.g., attached, fixed, welded, fastened, riveted, adhesively attached, bonded, pinned, press-fit, etc.) to the internal combustion engine. In other embodiments, the intake chamber 108 is integrally formed with the internal combustion engine. As utilized herein, two or more elements are “integrally formed” with each when the two or more elements are formed and joined together as part of a single manufacturing process to create a single-piece or unitary construction that cannot be disassembled without an at least partial destruction of the overall component. The intake chamber 108 may be centered on the conduit axis 106 (e.g., the conduit axis 106 extends through a center point of the intake chamber 108, etc.). In some embodiments, the intake chamber 108 may be offset from the conduit axis 106 (e.g., the conduit axis 106 extends adjacent to a center point of the intake chamber 108, etc.).

In some embodiments, the exhaust conduit system 104 also includes an introduction conduit 109 (e.g., conduit, exhaust conduit, decomposition housing, decomposition reactor, decomposition chamber, reactor pipe, decomposition tube, reactor tube, etc.). The introduction conduit 109 is configured to receive exhaust from the intake chamber 108. In various embodiments, the introduction conduit 109 is coupled to the intake chamber 108. For example, the introduction conduit 109 may be fastened (e.g., using a band, using bolts, using twist-lock fasteners, threaded, etc.), welded, riveted, or otherwise attached to the intake chamber 108. In other embodiments, the introduction conduit 109 is integrally formed with the intake chamber 108. As utilized herein, the terms “fastened,” “fastening,” and the like, describe attachment (e.g., joining, etc.) of two structures in such a way that detachment (e.g., separation, etc.) of the two structures remains possible while “fastened” or after the “fastening” is completed, without destroying or damaging either or both of the two structures. The introduction conduit 109 is centered on the conduit axis 106 (e.g., the conduit axis 106 extends through a center point of the introduction conduit 109, etc.). In some embodiments, the introduction conduit 109 is formed by the coupling of the individual housings and chambers, as described herein.

The aftertreatment system 100 also includes a reductant fluid delivery system 110. As is explained in more detail herein, the reductant fluid delivery system 110 is configured to facilitate the introduction of a reductant fluid, such as a reductant (e.g., diesel exhaust fluid (DEF), Adblue®, a urea-water solution (UWS), an aqueous urea solution, AUS32, etc.) into the exhaust within the exhaust. When the reductant is introduced into the exhaust, reduction of emission of undesirable components in the exhaust using the aftertreatment system 100 may be facilitated. When the hydrocarbon fluid is introduced into the exhaust, the temperature of the exhaust may be increased (e.g., to facilitate regeneration of components of the aftertreatment system 100, etc.). For example, the temperature of the exhaust may be increased by combusting the hydrocarbon fluid within the exhaust (e.g., using a spark plug, etc.).

The reductant fluid delivery system 110 includes an intake chamber dosing module 112 (e.g., doser, reductant doser, etc.). The intake chamber dosing module 112 is configured to facilitate passage of the reductant fluid through the intake chamber 108 and into intake chamber 108. In some embodiments, the intake chamber dosing module 112 is positioned within a dosing module mount. The dosing module mount is configured to facilitate mounting of the intake chamber dosing module 112 to the intake chamber 108. The dosing module mount may provide insulation (e.g., thermal insulation, vibrational insulation, etc.) between the intake chamber dosing module 112 and the intake chamber 108. In some embodiments, the reductant fluid delivery system 110 does not include the intake chamber dosing module 112. In some embodiments the intake chamber dosing module 112 is a close coupled dosing module. That is, the intake chamber dosing module 112 is coupled to the introduction conduit 109 proximate an outlet of the internal combustion engine system 101 (e.g., proximate an outlet of the engine and/or proximate an outlet of the turbocharger 102). For example, the intake chamber dosing module 112 may be coupled to the introduction conduit 109 downstream from the internal combustion engine system 101 and/or the turbocharger 102.

The reductant fluid delivery system 110 also includes a reductant fluid source 114 (e.g., reductant tank, etc.). The reductant fluid source 114 is configured to contain the reductant fluid. The reductant fluid source 114 is configured to provide the reductant fluid to the intake chamber dosing module 112. The reductant fluid source 114 may include multiple reductant fluid sources 114 (e.g., multiple tanks connected in series or in parallel, etc.). The reductant fluid source 114 may include, for example, a diesel exhaust fluid tank containing Adblue®.

The reductant fluid delivery system 110 also includes a reductant fluid pump 116 (e.g., supply unit, etc.). The reductant fluid pump 116 is configured to receive the reductant fluid from the reductant fluid source 114 and to provide the reductant fluid to the intake chamber dosing module 112. The reductant fluid pump 116 is used to pressurize the reductant fluid from the reductant fluid source 114 for delivery to the intake chamber dosing module 112. In some embodiments, the reductant fluid pump 116 is pressure-controlled. In some embodiments, the reductant fluid pump 116 is coupled to a chassis of a vehicle associated with the aftertreatment system 100.

In some embodiments, the reductant fluid delivery system 110 also includes a reductant fluid filter 118. The reductant fluid filter 118 is configured to receive the reductant fluid from the reductant fluid source 114 and to provide the reductant fluid to the reductant fluid pump 116. The reductant fluid filter 118 filters the reductant fluid prior to the reductant fluid being provided to internal components of the reductant fluid pump 116. For example, the reductant fluid filter 118 may inhibit or reduce the transmission of solids to the internal components of the reductant fluid pump 116. In this way, the reductant fluid filter 118 may facilitate and/or prolong desirable operation of the reductant fluid pump 116.

The intake chamber dosing module 112 includes at least one intake chamber dosing module injector 120 (e.g., insertion device, etc.). The intake chamber dosing module injector 120 is configured to receive the reductant fluid from the reductant fluid pump 116. The intake chamber dosing module injector 120 is configured to dose (e.g., provide, inject, insert, etc.) the reductant fluid received by the intake chamber dosing module 112 into the exhaust within the intake chamber 108.

In some embodiments, the reductant fluid delivery system 110 also includes an air pump 122 and an air source 124 (e.g., air intake, etc.). The air pump 122 is configured to receive air from the air source 124. The air pump 122 is configured to provide the air to the intake chamber dosing module 112. In some applications, the intake chamber dosing module 112 is configured to mix the air and the reductant fluid into an air-reductant fluid mixture and to provide the air-reductant fluid mixture to the intake chamber dosing module injector 120 (e.g., for dosing into the exhaust within the intake chamber 108, etc.). As used herein, it is understood that a reductant fluid may include an air-reductant fluid mixture.

The intake chamber dosing module injector 120 is configured to receive the air from the air pump 122. The intake chamber dosing module injector 120 is configured to dose the air into the exhaust within the intake chamber 108. In some embodiments, the reductant fluid delivery system 110 also includes an air filter 126. The air filter 126 is configured to receive the air from the air source 124 and to provide the air to the air pump 122. The air filter 126 is configured to filter the air prior to the air being provided to the air pump 122. In some embodiments, the reductant fluid delivery system 110 does not include the air pump 122, the air source 124, or both. In such embodiments, the intake chamber dosing module 112 is not configured to mix the reductant fluid with the air.

In some embodiments, the intake chamber dosing module 112 is configured to receive the air and the reductant fluid, and doses both the air and the reductant fluid into the intake chamber 108. In some embodiments, the intake chamber dosing module 112 is configured to receive the reductant fluid (and does not receive air), and doses the reductant fluid into the intake chamber 108.

The aftertreatment system 100 also includes an aftertreatment system controller 128 (e.g., control circuit, driver, etc.). The intake chamber dosing module 112, the reductant fluid pump 116, and the air pump 122 are also electrically or communicatively coupled to the aftertreatment system controller 128. The aftertreatment system controller 128 is configured to control the intake chamber dosing module 112 to dose the reductant fluid into the intake chamber 108. The aftertreatment system controller 128 may also be configured to control the reductant fluid pump 116 and/or the air pump 122 in order to control the reductant fluid that is dosed into the intake chamber 108.

The aftertreatment system controller 128 includes an aftertreatment system processing circuit 130. The aftertreatment system processing circuit 130 includes an aftertreatment system processor 132 and an aftertreatment system memory 134. The aftertreatment system processor 132 may include a microprocessor, an application-specific integrated circuit (ASIC), a field-programmable gate array (FPGA), etc., or combinations thereof. The aftertreatment system memory 134 may include, but is not limited to, electronic, optical, magnetic, or any other storage or transmission device capable of providing a processor, ASIC, FPGA, etc. with program instructions. The aftertreatment system memory 134 may include a memory chip, Electrically Erasable Programmable Read-Only Memory (EEPROM), Erasable Programmable Read Only Memory (EPROM), flash memory, or any other suitable memory from which the aftertreatment system controller 128 can read instructions. The instructions may include code from any suitable programming language. The aftertreatment system memory 134 may include various modules that include instructions that are configured to be implemented by the aftertreatment system processor 132.

In various embodiments, the aftertreatment system controller 128 is configured to communicate with a central controller 136 (e.g., engine control unit (ECU), engine control module (ECM), etc.) to control the turbocharger 102. The turbocharger 102 includes a compressor wheel coupled to an exhaust turbine wheel via a connector shaft, where hot exhaust spins the turbine wheel, thereby rotating the shaft and the compressor wheel to draw air in. By compressing the air, the turbocharger 102 allows for more air to enter the cylinders (or combustion chamber) to burn more fuel and increase power and efficiency. The turbocharger 102 may include a heat exchanger to cool the compressed air before the air enters the cylinders.

In some embodiments, the central controller 136 is communicable with a display device (e.g., screen, monitor, touch screen, heads up display (HUD), indicator light, etc.). The display device may be configured to change state in response to receiving information from the central controller 136. For example, the display device may be configured to change between a static state and an alarm state based on a communication from the central controller 136. By changing the state, the display device may provide an indication to a user of a status of the reductant fluid delivery system 110.

The aftertreatment system 100 includes an upstream catalyst member 138 (e.g., selective catalytic reduction (SCR) catalyst member, conversion catalyst member, catalytic metals, etc.). The upstream catalyst member 138 is positioned downstream of the intake chamber 108. The upstream catalyst member 138 is configured to cause decomposition of components of the exhaust using the reductant fluid (e.g., via catalytic reactions, etc.). The upstream catalyst member 138 includes an upstream catalyst housing 140. The upstream catalyst housing 140 may be coupled to the intake chamber 108. In some embodiments, the upstream catalyst housing 140 is integrally formed with the intake chamber 108. The upstream catalyst member 138 includes an upstream catalyst substrate 142. The upstream catalyst substrate 142 is coupled to the upstream catalyst housing 140. In some embodiments, the upstream catalyst substrate 142 is integrally formed with the upstream catalyst housing 140.

The upstream catalyst member 138 receives the exhaust from the intake chamber 108. The exhaust flows through the upstream catalyst substrate 142 and reacts with the upstream catalyst substrate 142 so as to cause the exhaust to undergo the processes of evaporation, thermolysis, and/or hydrolysis to form non-NOₓ emissions within the introduction conduit 109 and/or the upstream catalyst member 138. In some embodiments, the exhaust and the reductant fluid within the exhaust react with the upstream catalyst substrate 142. In this regard, the upstream catalyst member 138 is configured to assist the reduction of NOₓ emissions by accelerating a NOₓ reduction process between the reductant and the NOₓ of the exhaust into diatomic nitrogen, water, and/or carbon dioxide. The upstream catalyst substrate 142 may include vanadia (vanadium (V) oxide, V₂O₅). Vanadia may be used due to its lengthy deactivation time and the ability to react with the exhaust at high temperatures. In some embodiments, vanadia is used for emitting lower N₂O emissions into the environment when exhaust temperatures are below about 420° C.

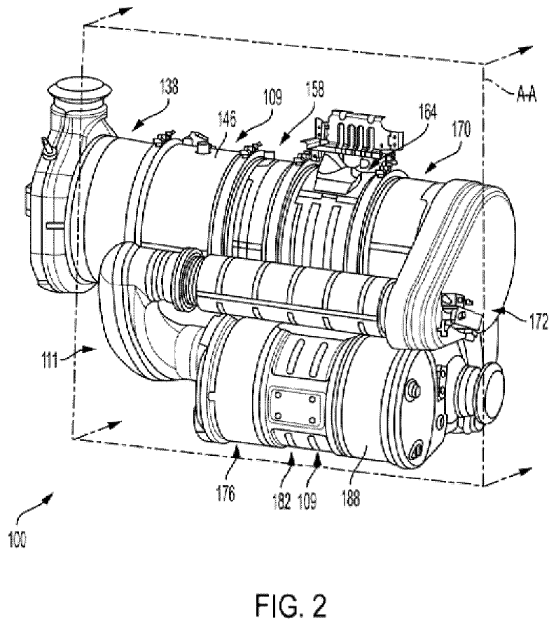

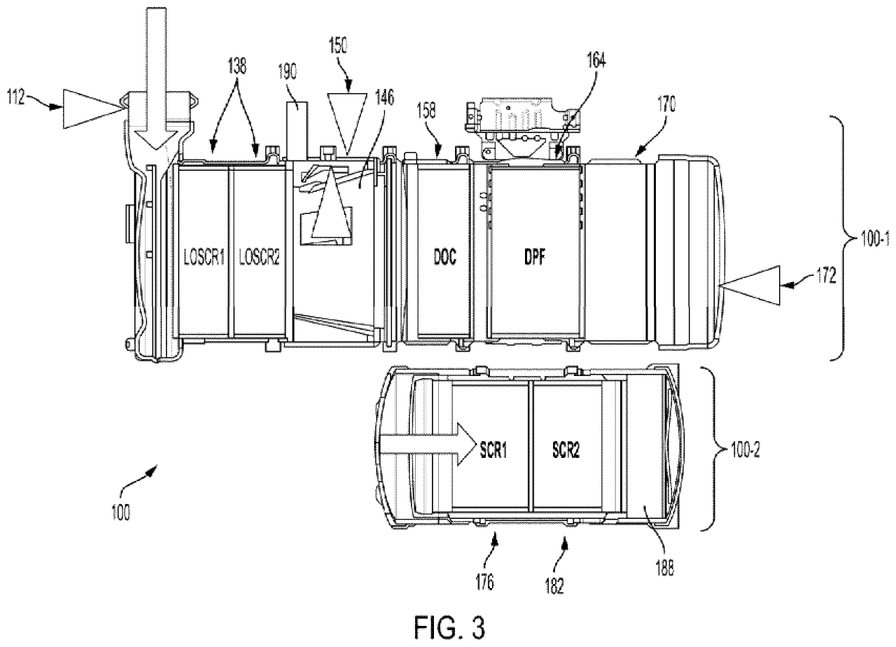

In some embodiments, referring to FIGS. 2 and 3, the aftertreatment system 100 includes more than one upstream catalyst members positioned downstream of the intake chamber 108. For example, the aftertreatment system 100 may include two upstream catalyst members 138. In some embodiments, the upstream catalyst members 138 may be considered “light-off” (LO) upstream catalyst members (e.g., LOSCR1 and LOSCR2, respectively) located immediately downstream of the internal combustion engine system 101. In some instances, the light-off upstream catalyst member(s) 138 may be heated up by the exhaust quickly to attain a desirable temperature suitable for treating the exhaust by the upstream catalyst substrate 142. For example, the desirable temperature (e.g., a light-off temperature) may be a temperature at which catalytic reactions between the exhaust and the upstream catalyst substrate 142 are initiated. As will be discussed in detail herein, it may be desirable to obtain measurement of an amount of NOₓ emission in the exhaust downstream of the LO upstream catalyst member(s) 138.

The aftertreatment system 100 includes an upstream ammonia slip catalyst (ASC) substrate 144. The upstream ammonia slip catalyst substrate 144 is positioned downstream of the upstream catalyst member 138. In some embodiments, the upstream ammonia slip catalyst substrate 144 is a coating applied to a portion of the outlet of the upstream catalyst member 138. The upstream ammonia slip catalyst substrate 144 is configured to receive the exhaust from the upstream catalyst member 138 and assist in the reduction of the byproducts (e.g., ammonia, etc.) of the processes of the intake chamber dosing module 112 and the upstream catalyst member 138. Specifically, the intake chamber dosing module 112 may introduce ammonia into the exhaust, though a portion of the ammonia introduced may not react with the exhaust. As a result, excess ammonia may slip from the upstream catalyst member 138 into the exhaust downstream of the upstream catalyst member 138. The upstream ammonia slip catalyst substrate 144 functions to reduce the ammonia such that the exhaust downstream of the upstream ammonia slip catalyst substrate 144 does not contain an undesirable amount of ammonia. In some embodiments, referring to FIGS. 2 and 3, the aftertreatment system 100 does not include the upstream ammonia slip catalyst substrate 144.

The aftertreatment system 100 also includes a hydrocarbon mixer 146 (e.g., hydrocarbon decomposition chamber, hydrocarbon mixing chamber mixer, etc.). The hydrocarbon decomposition chamber is positioned downstream of the upstream catalyst member 138 (and downstream of the upstream ammonia slip catalyst substrate 144, if present). In some embodiments, the hydrocarbon mixer 146 is coupled to the upstream catalyst housing 140. In some embodiments, the hydrocarbon mixer 146 is integrally formed with the upstream catalyst housing 140. In still other embodiments, the hydrocarbon mixer 146 is coupled to the intake chamber 108. The hydrocarbon mixer 146 is configured to receive the exhaust from the upstream ammonia slip catalyst substrate 144.

The aftertreatment system 100 includes a hydrocarbon fluid system 147. The hydrocarbon fluid system 147 includes a hydrocarbon dosing module 148. The hydrocarbon dosing module 148 doses the exhaust within the hydrocarbon mixer 146 with a hydrocarbon fluid. The hydrocarbon dosing module 148 is configured to facilitate passage of hydrocarbon fluid into the hydrocarbon mixer 146. The hydrocarbon dosing module 148 includes at least one hydrocarbon injector 150 (e.g., insertion device, etc.). The hydrocarbon injector 150 is configured to dose the hydrocarbon fluid into the exhaust within the hydrocarbon mixer 146. The hydrocarbon injector 150 is centered on an injection axis 155.

The hydrocarbons within the hydrocarbon mixer 146 may be configured to increase the temperature of the exhaust within the hydrocarbon mixer 146. Specifically, the aftertreatment system 100 includes an igniter 151 (e.g., spark plug, etc.) coupled to the hydrocarbon mixer 146. The igniter 151 is electrically connected to the aftertreatment system controller 128 and is configured to combust the hydrocarbon fluid in the exhaust within the hydrocarbon mixer 146, causing an increase in temperature of the exhaust. Consequently, regeneration of downstream components may occur. For example, regeneration occurs when the hydrocarbon fluid in the exhaust combust and increase the temperature of the exhaust such that the exhaust burns any soot or particles which may be affixed to the downstream components. By burning the affixed soot or particles, the downstream components may be cleaned off such that they are like new and operate as such.

The hydrocarbon fluid system 147 further includes a hydrocarbon source 152 (e.g., hydrocarbon tank, etc.). The hydrocarbon source 152 is configured to contain the hydrocarbon fluid. The hydrocarbon source 152 is configured to provide the hydrocarbon fluid to the hydrocarbon dosing module 148. The hydrocarbon source 152 may include multiple hydrocarbon sources 152 (e.g., multiple tanks connected in series or in parallel, etc.). The hydrocarbon fluid system 147 also includes a hydrocarbon fluid pump 154. Specifically, the hydrocarbon fluid pump 154 is configured to provide hydrocarbon fluid to the hydrocarbon injector 150. The hydrocarbon injector 150 receives hydrocarbon fluid from the hydrocarbon fluid pump 154 and is configured to dose the hydrocarbon fluid received by the hydrocarbon dosing module 148 into the exhaust within the hydrocarbon mixer 146. The hydrocarbon fluid pump 154 is used to pressurize the hydrocarbon fluid received from the hydrocarbon source 152 for delivery to the hydrocarbon dosing module 148 and the hydrocarbon injector 150. In some embodiments, the hydrocarbon fluid pump 154 is pressure controlled. In some embodiments, the hydrocarbon fluid pump 154 is coupled to a chassis of a vehicle associated with the aftertreatment system.

In some embodiments, the hydrocarbon fluid system 147 includes a hydrocarbon filter 156 (e.g., fuel filter, lubricant filter, oil filter, etc.). The hydrocarbon filter 156 is configured to receive the hydrocarbon fluid from the hydrocarbon source 152 and to provide the hydrocarbon fluid to the hydrocarbon fluid pump 154. The hydrocarbon filter 156 filters the hydrocarbon fluid prior to the hydrocarbons being provided to internal components of the hydrocarbon fluid pump 154. For example, the hydrocarbon filter 156 may inhibit or reduce the transmission of solids to the internal components of the hydrocarbon fluid pump 154. In this way, the hydrocarbon filter 156 may facilitate prolonged desirable operation of the hydrocarbon fluid pump 154.

In some embodiments, the air pump 122 is also configured to provide the air to the hydrocarbon dosing module 148. The hydrocarbon dosing module 148 is configured to provide the air into the hydrocarbon mixer 146. In some applications, the hydrocarbon dosing module 148 is configured to mix the air and the hydrocarbon fluid into an air-hydrocarbon fluid mixture and to provide the air-hydrocarbon fluid mixture to the hydrocarbon injector 150 (e.g., for dosing into the exhaust within the hydrocarbon mixer 146, etc.).

In various embodiments, the hydrocarbon dosing module 148 is configured to receive air and hydrocarbon fluid, and doses the mixture of air and hydrocarbon fluid into the hydrocarbon mixer 146. In various embodiments, the hydrocarbon dosing module 148 is configured to receive hydrocarbons, and doses the hydrocarbon into the hydrocarbon mixer 146.

In some embodiments, the hydrocarbon dosing module 148 and the hydrocarbon fluid pump 154 are also electrically or communicatively coupled to the aftertreatment system controller 128. The aftertreatment system controller 128 is further configured to control the hydrocarbon dosing module 148 to dose the hydrocarbon fluid into the hydrocarbon mixer 146. The aftertreatment system controller 128 may also be configured to control the hydrocarbon fluid pump 154 and/or the air pump 122 in order to control the hydrocarbon fluid that is dosed into the hydrocarbon mixer 146.

The aftertreatment system 100 includes a first oxidation catalyst member 158 (e.g., first diesel oxidation catalyst (DOC), etc.). The first oxidation catalyst member 158 is positioned downstream of the hydrocarbon mixer 146 (e.g., the hydrocarbon mixer 146 is positioned upstream of the first oxidation catalyst member 158).

The first oxidation catalyst member 158 includes a first oxidation catalyst housing 160. The first oxidation catalyst housing 160 is coupled to hydrocarbon mixer 146. The first oxidation catalyst housing 160 may also be integrally formed with the hydrocarbon mixer 146.

The first oxidation catalyst member 158 also includes a first oxidation catalyst substrate 162. The first oxidation catalyst substrate 162 is positioned within the first oxidation catalyst housing 160. The first oxidation catalyst substrate 162 may be coupled to the first oxidation catalyst housing 160. The exhaust including hydrocarbon fluid reacts with the first oxidation catalyst substrate 162 and causes the conversion of the hydrocarbon fluid in the exhaust. For example, as the exhaust flows through the first oxidation catalyst substrate 162, the hydrocarbons react with the first oxidation catalyst substrate 162 and begin to oxidize. The first oxidation catalyst substrate 162 facilitates conversion of the carbon monoxide, the hydrocarbon fluid, and/or the air-hydrocarbon fluid mixture in the exhaust into carbon dioxide.

The aftertreatment system 100 also includes an upstream particulate filter assembly 164. The upstream particulate filter assembly 164 includes an upstream particulate filter housing 166. The upstream particulate filter housing 166 is positioned downstream of the first oxidation catalyst housing 160. In some embodiments, the upstream particulate filter housing 166 is integrally formed with the first oxidation catalyst housing 160. The upstream particulate filter assembly 164 includes an upstream particulate filter 168 (e.g., diesel particulate filter (DPF), filtration member, etc.). The upstream particulate filter 168 is disposed within the upstream particulate filter housing 166 such that the upstream particulate filter 168 is positioned downstream of the first oxidation catalyst member 158 (e.g., the first oxidation catalyst member 158 is positioned upstream of the upstream particulate filter 168). In some embodiments, the upstream particulate filter housing 166 and the upstream particulate filter 168 are positioned downstream of the intake chamber 108.

The upstream particulate filter 168 is configured to remove first particulates (e.g., soot, solidified particles of hydrocarbon fluid, ash, etc.) from the exhaust. For example, the upstream particulate filter 168 may receive exhaust (e.g., from the first oxidation catalyst member 158, from the intake chamber 108, etc.) having a first concentration of the first particulates and may provide the exhaust downstream having a second concentration of the first particulates, where the second concentration is lower than the first concentration. In this way, the upstream particulate filter 168 may facilitate reduction of a particulate number (PN) of the exhaust. Decreasing the PN of the exhaust may be desirable in a variety of applications. For example, emissions regulations may prescribe a maximum PN for exhaust emitted to atmosphere and the upstream particulate filter 168 may ensure that the PN of the exhaust emitted to atmosphere by the aftertreatment system 100 is below the maximum PN.

In some embodiments, the upstream particulate filter 168 is a catalyzed DPF. The catalyzed DPF is a filter that has a catalyst coating. The catalyst coating is configured to react with a component of the exhaust to reduce undesirable components in the exhaust. For example, the catalyst coating could be an oxidation catalyst to reduce hydrocarbon fluid within the exhaust. In some embodiments, the catalyst coating is a SCR catalyst configured to reduce NOₓ emissions. In some embodiments, the aftertreatment system 100 includes a pressure sensor 169. The pressure sensor 169 is configured to provide a signal to the aftertreatment system controller 128. The aftertreatment system controller 128 is configured to determine a pressure difference between an inlet of the upstream particulate filter assembly 164 and an outlet of the upstream particulate filter assembly 164 based on the signal from the pressure sensor 169. The pressure difference may be indicative of the reduction of the PN of the exhaust.

The aftertreatment system 100 also includes a mixer 170 (e.g., swirl generating device, etc.). The mixer 170 is positioned downstream of the upstream particulate filter assembly 164 (e.g., the mixer 170 is positioned downstream of the upstream particulate filter 168) and configured to receive exhaust from the upstream particulate filter assembly 164. The mixer 170 may be coupled to the upstream particulate filter housing 166. In some embodiments, the mixer 170 is integrally formed with the upstream particulate filter housing 166. In some embodiments, the mixer 170 is positioned upstream of the first oxidation catalyst member 158.

The reductant fluid delivery system 110 includes a dosing module 172. The dosing module 172 is configured to facilitate passage of the reductant fluid into the mixer 170 and through the mixer 170. In some embodiments, the dosing module 172 is positioned within a dosing module mount. The dosing module mount is configured to facilitate mounting of the dosing module 172 to the mixer 170. The dosing module mount may provide insulation (e.g., thermal insulation, vibrational insulation, etc.) between the dosing module 172 and the decomposition chamber.

The dosing module 172 includes at least one injector 174 (e.g., insertion device, etc.). The injector 174 is configured to receive the reductant fluid from the reductant fluid pump 116. The injector 174 is configured to dose the reductant fluid received by the dosing module 172 into the exhaust within the mixer 170. In some embodiments, the injector 174 is centered on an injection axis 175. The injection axis 175 intersects with and is orthogonal to the conduit axis 106. In some embodiments, the injection axis 175 intersects with the conduit axis 106 and extends at an angle away from the conduit axis 106.

In some embodiments, the dosing module 172 is configured to receive air from the air pump 122. In some applications, the dosing module 172 is configured to mix the air and the reductant fluid into an air-reductant fluid mixture and to provide the air-reductant fluid mixture to the injector 174 (e.g., for dosing into the exhaust within the mixer 170, etc.). Specifically, the injector 174 is configured to receive the air from the air pump 122. The intake chamber dosing module injector 120 is configured to dose the air into the exhaust within the mixer 170.

In various embodiments, the dosing module 172 is configured to receive air and reductant fluid, and doses the mixture of air and reductant fluid into the mixer 170. In various embodiments, the dosing module 172 is configured to receive reductant fluid (and does not receive air), and doses the reductant fluid into the mixer 170. In various embodiments, the dosing module 172 is configured to receive reductant fluid, and doses the reductant fluid into the mixer 170.

In some embodiments, the aftertreatment system 100 includes a second oxidation catalyst member (e.g., second diesel oxidation catalyst (DOC), etc.). The second oxidation catalyst is positioned downstream of the mixer 170. The second oxidation catalyst is substantially similar to the first oxidation catalyst and therefore is not described in further detail.

The aftertreatment system 100 includes a first downstream catalyst member 176 (e.g., conversion catalyst member, SCR catalyst member, catalytic metals, etc.). The first downstream catalyst member 176 is positioned downstream of the mixer 170. In some embodiments, the first downstream catalyst member 176 is downstream of the second oxidation catalyst. The first downstream catalyst member 176 is configured to cause decomposition of components of the exhaust using the reductant fluid (e.g., via catalytic reactions, etc.). The first downstream catalyst member 176 includes a first downstream catalyst housing 178 and a first downstream catalyst substrate 180. The first downstream catalyst housing 178 may be coupled to the mixer 170. In some embodiments, the first downstream catalyst housing 178 is integrally formed with the mixer 170. The first downstream catalyst substrate 180 is coupled to the first downstream catalyst housing 178. In some embodiments, the first downstream catalyst substrate 180 is integrally formed with the first downstream catalyst housing 178.

The first downstream catalyst member 176 receives the exhaust from the mixer 170. The exhaust flows through the first downstream catalyst substrate 180 and reacts with the first downstream catalyst substrate 180 so as to cause the exhaust to undergo the processes of evaporation, thermolysis, and/or hydrolysis to form non-NOₓ emissions within the introduction conduit 109 and/or the first downstream catalyst member 176. In some embodiments, the exhaust and the reductant fluid within the exhaust react with the first downstream catalyst substrate 180. In this way the first downstream catalyst member 176 is configured to assist the reduction of NOₓ emissions by accelerating a NOₓ reduction process between the reductant and the NOₓ of the exhaust into diatomic nitrogen, water, and/or carbon dioxide and also configured to assist in the reduction of particulates from the exhaust. The first downstream catalyst member 176 may include iron zeolite. The first downstream catalyst member 176 may include copper zeolite. In some embodiments, the aftertreatment system 100 does not include a first downstream catalyst member 176.

The aftertreatment system 100 also includes a second downstream catalyst member 182 (e.g., conversion catalyst member, SCR catalyst member, catalytic metals, etc.). The second downstream catalyst member 182 is positioned downstream of the mixer 170. The second downstream catalyst member 182 is configured to cause decomposition of components of the exhaust using the reductant fluid (e.g., via catalytic reactions, etc.). The second downstream catalyst member 182 includes a second downstream catalyst housing 184. In some embodiments, the second downstream catalyst housing 184 is integrally formed with the first downstream catalyst housing 178. In some embodiments, the second downstream catalyst housing 184 is the first downstream catalyst housing 178. The second downstream catalyst member 182 includes a second downstream catalyst substrate 186. The second downstream catalyst substrate 186 is coupled to the second downstream catalyst housing 184. In some embodiments, the second downstream catalyst substrate 186 is integrally formed with the second downstream catalyst housing 184.

The second downstream catalyst member 182 receives the exhaust from the first downstream catalyst member 176. The exhaust flows through the second downstream catalyst substrate 186 and reacts with the second downstream catalyst substrate 186 so as to cause the exhaust to undergo the processes of evaporation, thermolysis, and/or hydrolysis to form non-NOₓ emissions within the introduction conduit 109 and/or the second downstream catalyst member 182. In some embodiments, the exhaust and the reductant fluid within the exhaust react with the second downstream catalyst substrate 186. In this way, the second downstream catalyst member 182 is configured to assist the reduction of NOₓ emissions by accelerating a NOₓ reduction process between the reductant and the NOₓ of the exhaust into diatomic nitrogen, water, and/or carbon dioxide, and also configured to assist in the reduction of particulates from the exhaust. The second downstream catalyst member 182 may include iron zeolite. The second downstream catalyst member 182 may include copper zeolite. In some embodiments, the aftertreatment system 100 does not include a second downstream catalyst member 182.

The aftertreatment system 100 includes a downstream ammonia slip catalyst substrate 188. The downstream ammonia slip catalyst substrate 188 is positioned downstream of the second downstream catalyst member 182. In some embodiments, the downstream ammonia slip catalyst substrate 188 is a coating applied to a portion of the outlet of the first downstream catalyst member 176. The downstream ammonia slip catalyst substrate 188 may be a coating applied to a portion of the outlet of the second downstream catalyst member 182. The downstream ammonia slip catalyst substrate 188 is configured to receive the exhaust from the second downstream catalyst member 182 and assist in the reduction of the byproducts (e.g., ammonia, etc.) of the processes of the dosing module 172 and the second downstream catalyst member 182. In some embodiments, the downstream ammonia slip catalyst substrate 188 is positioned downstream of the first downstream catalyst member 176 and is configured to receive the exhaust from the first downstream catalyst member 176 and assist in the reduction of the byproducts (e.g., ammonia, etc.) of the processes of the dosing module 172 and the first downstream catalyst member 176. Specifically, the dosing module 172 may introduce ammonia into the exhaust, however a portion of the ammonia introduced may not react with the exhaust. As a result, excess ammonia may slip from the first downstream catalyst member 176 and/or the second downstream catalyst member 182 into the exhaust downstream of the first downstream catalyst member 176 and/or the second downstream catalyst member 182 such that the exhaust downstream of the downstream ammonia slip catalyst substrate 188 does not contain an undesirable amount of ammonia. In some embodiments, the aftertreatment system 100 does not include the downstream ammonia slip catalyst substrate 188.

The aftertreatment system 100 also includes an outlet chamber 189. The outlet chamber 189 is positioned downstream of the downstream ammonia slip catalyst substrate 188 and is configured to receive the exhaust from downstream ammonia slip catalyst substrate 188. In various embodiments, the outlet chamber 189 is coupled to the downstream ammonia slip catalyst substrate 188. For example, the outlet chamber 189 may be fastened, welded, riveted, or otherwise attached to the downstream ammonia slip catalyst substrate 188. In some embodiments, the outlet chamber 189 is coupled to the introduction conduit 109. In some embodiments, the outlet chamber 189 is the introduction conduit 109 (e.g., only the introduction conduit is included in the exhaust conduit system 104 and the introduction conduit 109 functions as both the introduction conduit 109 and the outlet chamber 189). The outlet chamber 189 is centered on the conduit axis 106 (e.g., the conduit axis 106 extends through a center point of the outlet chamber 189, etc.).

In various embodiments, the exhaust conduit system 104 only includes a single conduit that functions as the intake chamber 108, the introduction conduit 109, and the outlet chamber 189.

In some embodiments, referring to FIGS. 2 and 3, the aftertreatment system 100 includes an elbow conduit 111 positioned downstream of the upstream particulate filter assembly 164 (and the mixer 170) and is contiguous with the introduction conduit 109. The elbow conduit 111 is configured to receive exhaust from the upstream particulate filter assembly 164 in a first direction and facilitate a change of direction of the exhaust. For example, the elbow conduit 111 receives the exhaust in a first direction and causes the exhaust to change from a first direction to a second direction that is parallel to and opposite of the first direction. The exhaust may then flow to the first downstream catalyst member 176, which is positioned downstream of the elbow conduit 111 and parallel to the upstream catalyst members 138 and the hydrocarbon mixer 146, for example. A portion 100-1 in FIG. 3, which is a cross-sectional view of the aftertreatment system 100 along the plane A-A, illustrates a portion of the introduction conduit 109 upstream of the elbow conduit 111, and a portion 100-2 illustrates a portion of the introduction conduit 109 downstream of the elbow conduit 111. The elbow conduit 111 may provide certain benefits. For example, the total length of the aftertreatment system 100 is reduced and total space necessary for the aftertreatment system 100 is reduced.

In various embodiments, the aftertreatment system 100 includes a sensor 191 (e.g., NOₓ sensor, CO sensor, CO₂ sensor, O₂ sensor, temperature sensor, particulate sensor, nitrogen sensor, etc.). The sensor 191 is positioned upstream of the downstream ammonia slip catalyst substrate 188. In some embodiments, the sensor 191 is positioned upstream of the upstream catalyst members 138, as depicted in FIG. 1. In some embodiments, the sensor 191 is coupled to the intake chamber 108. The sensor 191 is configured to measure (e.g., sense, detect, etc.) a signal associated with a parameter (e.g., NOₓ concentration, CO concentration, CO₂ concentration, O₂ concentration, temperature, particulate concentration, nitrogen concentration, sulfur oxide (SOₓ) concentration, etc.) of the exhaust and the reductant fluid upstream of the upstream particulate filter 168. The sensor 191 may be configured to measure a signal associated with the parameter of the exhaust within the intake chamber 108. In some embodiments, the parameter is a temperature of the exhaust upstream of the downstream ammonia slip catalyst substrate 188, and the sensor 191 may be referred to as an exhaust gas temperature sensor (EGTS). In some embodiments, the parameter is the particulate concentration in the exhaust upstream of the downstream ammonia slip catalyst substrate 188. In some embodiments, the parameter is the SOₓ concentration of the exhaust upstream of the downstream ammonia slip catalyst substrate 188. In some embodiments, the sensor 191 measures signals associated with the one or more of the temperature, the particulate concentration, and the SOₓ concentration of the exhaust upstream of the downstream ammonia slip catalyst substrate 188.

In some embodiments, the aftertreatment system 100 includes sensors 192, 193, 194, 195, 196, and 197, which are each similar to the sensor 191 in function and means of operation. For example, the sensors 192, 193, 194, 195, 196, and 197 may each be configured as a NOₓ sensor, a CO sensor, a CO₂ sensor, an O₂ sensor, a temperature sensor, a particulate sensor, a nitrogen sensor, a SOₓ sensor, or the like. The sensors 192, 193, 194, 195, 196, and 197 may be coupled to the introduction conduit 109 and/or the outlet chamber 189 at various positions, such that they may each be configured to measure (e.g., sense, detect, etc.) a signal associated with a parameter (e.g., NOₓ concentration, CO concentration, CO₂ concentration, O₂ concentration, temperature, particulate concentration, nitrogen concentration, SOₓ concentration, etc.) of the exhaust and/or the reductant fluid. In some embodiments, the sensors 192, 193, 194, 195, and 196 are configured to measure a signal associated with a parameter of the exhaust upstream of the downstream ammonia slip catalyst substrate 188, and the sensor 197 is configured to measure a signal associated with a parameter of the exhaust downstream of the downstream ammonia slip catalyst substrate 188.

For example, the sensor 192 may be configured to measure a signal associated with a temperature of the exhaust downstream of the upstream ammonia slip catalyst substrate 144; the sensor 193 may be configured to measure a signal associated with the temperature of the exhaust downstream of the hydrocarbon mixer 146; the sensor 194 may be configured to measure a signal associated with the temperature of the exhaust downstream of the first oxidation catalyst member 158; the sensor 195 may be configured to measure a signal associated with the temperature of the exhaust downstream of the upstream particulate filter assembly 164; the sensor 196 may be configured to measure a signal associated with the temperature of the exhaust downstream of the mixer 170; and the sensor 197 may be configured to measure a signal associated with the temperature of the exhaust downstream of the downstream ammonia slip catalyst substrate 188. In this regard, the sensors 192, 193, 194, 195, 196, and 197 may be referred to as exhaust gas temperature sensors, or EGTSs.

In some embodiments, the aftertreatment system 100 includes one or more of the sensors 192, 193, 194, 195, 196, and 197. In some embodiments, the sensors 192, 193, 194, 195, 196, and 197 may be omitted from the aftertreatment system 100.

In various embodiments, the aftertreatment system 100 also includes a sensor 198 (e.g., NOₓ sensor, CO sensor, CO₂ sensor, O₂ sensor, particulate sensor, nitrogen sensor, SOₓ sensor, etc.). The sensor 198 is positioned downstream of the downstream ammonia slip catalyst substrate 188. In some embodiments, the sensor 198 is coupled to the outlet chamber 189. The sensor 198 is configured to measure (e.g., sense, detect, etc.) a signal associated with a parameter (e.g., NOₓ concentration, CO concentration, CO₂ concentration, O₂ concentration, particulate concentration, nitrogen concentration, SOₓ concentration, etc.) of the exhaust and the reductant fluid downstream of the downstream ammonia slip catalyst substrate 188. The sensor 198 may be configured to measure the signal associated with a parameter within the outlet chamber 189. In some embodiments, the parameter is the particulate concentration in the exhaust downstream of the downstream ammonia slip catalyst substrate 188. In some embodiments, the parameter is the SOₓ concentration of the exhaust within the outlet chamber 189. In some embodiments, the sensor 198 measures signals associated with both the particulate concentration and the SOₓ concentration.

In various embodiments, the aftertreatment system 100 also includes a sensor 199 (e.g., NOₓ sensor, CO sensor, CO₂ sensor, O₂ sensor, particulate sensor, nitrogen sensor, SOₓ concentration sensor, etc.). The sensor 199 is positioned downstream of the downstream ammonia slip catalyst substrate 188. In some embodiments, the sensor 199 is coupled to the outlet chamber 189. The sensor 199 is configured to measure (e.g., sense, detect, etc.) a signal associated with a parameter (e.g., NOₓ concentration, CO concentration, CO₂ concentration, O₂ concentration, particulate concentration, nitrogen concentration, SOₓ concentration, etc.) of the exhaust and the reductant fluid downstream of the downstream ammonia slip catalyst substrate 188. The sensor 199 may be configured to measure a signal associated with the parameter of the exhaust within the outlet chamber 189. In some embodiments, the parameter is the particulate concentration in the exhaust downstream of the downstream ammonia slip catalyst substrate 188. In some embodiments, the parameter is the NOₓ concentration of the exhaust downstream of the downstream ammonia slip catalyst substrate 188. In some embodiments, the sensor 199 measures signals associated with both the particulate concentration and the NOₓ concentration.

In various embodiments, the aftertreatment system 100 includes a sensor 190 (e.g., NOₓ sensor, CO sensor, CO₂ sensor, O₂ sensor, particulate sensor, nitrogen sensor, SOₓ concentration sensor, etc.). The sensor 190 is positioned downstream of the upstream catalyst member 138 (and the upstream ammonia slip catalyst substrate 144, if present) and coupled to the hydrocarbon mixer 146. The sensor 190 is configured to measure (e.g., sense, detect, etc.) a signal associated with a parameter (e.g., NOₓ concentration, CO concentration, CO₂ concentration, O₂ concentration, particulate concentration, nitrogen concentration, SOₓ concentration, etc.) of the exhaust downstream of the upstream catalyst member 138. In some embodiments, the sensor 190 is configured to measure a signal associated with the parameter of the exhaust as it enters the hydrocarbon mixer 146 to be mixed with the hydrocarbon fluid. In some embodiments, the parameter is the NOₓ concentration of the exhaust downstream of the upstream catalyst member 138.

Each of the sensors 190-199 is electrically or communicatively coupled to the aftertreatment system controller 128 and is configured to provide a signal associated with the parameter to the aftertreatment system controller 128. The aftertreatment system controller 128 (e.g., via the aftertreatment system processing circuit 130, etc.) is configured to determine a measurement based on the signal. The aftertreatment system controller 128 may be configured to control the intake chamber dosing module 112, the dosing module 172, the reductant fluid pump 116, and/or the air pump 122 based on the signal. Furthermore, the aftertreatment system controller 128 may be configured to communicate the signal to the central controller 136.

### III. OVERVIEW OF EXAMPLE MIXERS

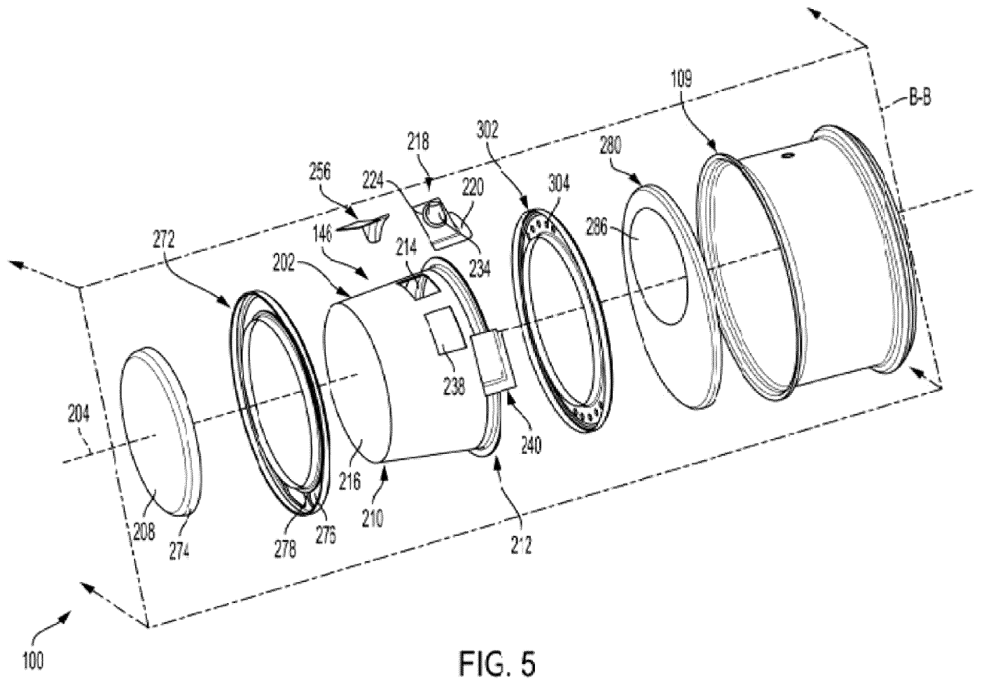

Referring to FIGS. 5-32, the hydrocarbon mixer 146 of the aftertreatment system 100 is shown in greater detail. The hydrocarbon mixer 146 is configured to receive exhaust via the introduction conduit 109. The hydrocarbon mixer 146 is also configured to receive hydrocarbon fluid from the hydrocarbon injector 150. The hydrocarbon mixer 146 is configured to mix the hydrocarbon fluid with the exhaust. The hydrocarbon mixer 146 is also configured to facilitate swirling (e.g., rotation, etc.) of the exhaust and mixing (e.g., combination, etc.) of the exhaust and the hydrocarbon fluid so as to disperse the hydrocarbon fluid within the exhaust downstream of the mixer (e.g., to increase the ability of the hydrocarbon fluid to heat the gas, etc.). By dispersing the hydrocarbon fluid within the exhaust using the hydrocarbon mixer 146, reduction of emission of undesirable components in the exhaust is enhanced and/or an ability of the aftertreatment system 100 to increase a temperature of the exhaust may be enhanced.

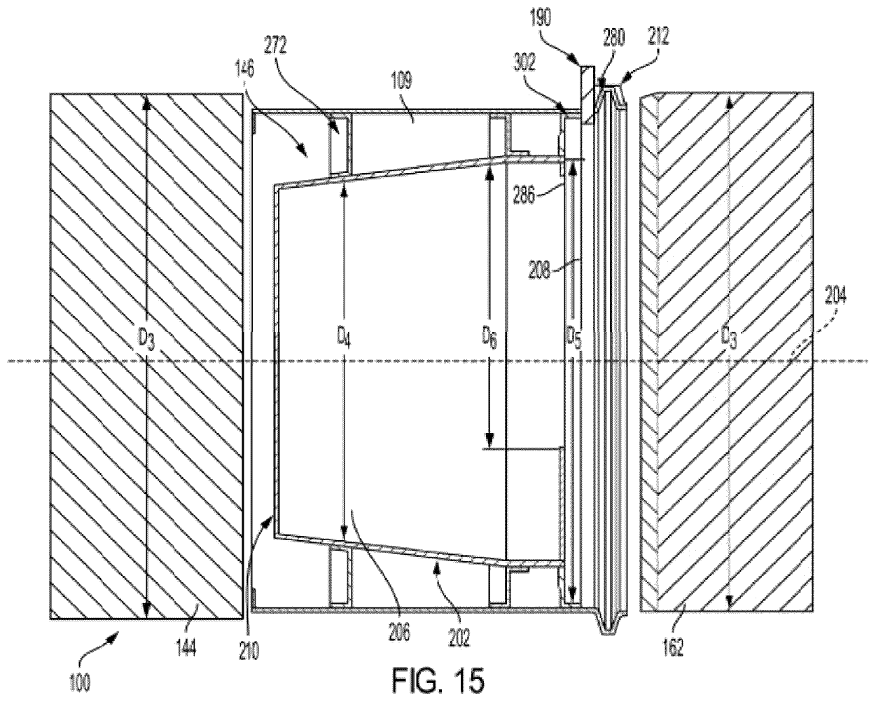

The hydrocarbon mixer 146 includes a mixer body 202 (e.g., shell, frame, etc.). The mixer body 202 is supported within the introduction conduit 109. The mixer body 202 is centered on a mixer body center axis 204. In some embodiments, the mixer body center axis 204 is the same as the conduit axis 106. In other embodiments, the mixer body center axis 204 is separated from the conduit axis 106. For example, the mixer body center axis 204 may be parallel to the conduit axis 106 and offset from the conduit axis 106. The mixer body 202 includes an inlet-side 210. The inlet-side 210 is positioned adjacent to and downstream of the upstream catalyst member 138. The outlet-side 212 is positioned adjacent to the first oxidation catalyst member 158. Referring to FIG. 15, for example, the mixer body 202 is bisected by a mixer body first plane 206 (e.g., mixer body plane, etc.) near or at the inlet-side 210. The mixer body first plane 206 intersects and is orthogonal to the mixer body center axis 204. In some embodiments, the mixer body first plane 206 intersects and is orthogonal to the conduit axis 106. The mixer body is bisected by a mixer body second plane 208 near or at the outlet-side 212. The mixer body second plane 208 intersects and is orthogonal to the mixer body center axis 204. In some embodiments, the mixer body second plane 208 intersects and is orthogonal to the conduit axis 106.

As shown in FIGS. 5-10, 15-18, 25, and 27-30, for example, the mixer body 202 may be tapered. In some embodiments, the mixer body 202 extends from the inlet-side 210 to the outlet-side 212 at an angle in a range of approximately 91 degrees (°) to approximately 102° (e.g., 91°, 93°, 95°, 97°, 99°, 99.6°, 100.6°, 101°, 102°, etc.). The mixer body 202 extends from the inlet-side 210 to the outlet-side 212 such that the height of the mixer body is in a range of approximately 120 mm to approximately 165 mm (e.g., 114 mm, 120 mm, 130 mm, 140 mm, 150 mm, 160 mm, 165 mm 173.25 mm, etc.).

The mixer body 202 includes a first aperture 214, as depicted in FIG. 5, for example. The first aperture 214 extends through the mixer body 202. The first aperture 214 may have a length along the mixer body 202 measured from the inlet-side 210 to the outlet-side 212 approximately in the range of 70 mm to 100 mm (e.g., 66.5 mm, 70 mm, 75 mm, 76.71 mm, 80 mm, 85 mm, 90 mm, 95 mm, 100 mm, 105 mm, etc.). In some embodiments, the first aperture 214 may have a width measured orthogonally from the length of the first aperture 214 in a range of approximately 70 mm to approximately 100 mm (e.g., 66.5 mm, 70 mm, 75 mm, 80 mm, 85 mm, 90 mm, 99.01 mm, 95 mm, 100 mm, 105 mm, etc.). The first aperture 214 is configured to facilitate flow of the exhaust from the outer portion of the mixer body 202 through the mixer body 202 and into a mixer body cavity 216 (e.g., void, etc.). The mixer body cavity 216 receives the exhaust from the first aperture 214. As is explained in more detail herein, the exhaust is caused to swirl within the mixer body 202, and this swirling facilitates mixing of the exhaust and the hydrocarbon fluid.

The hydrocarbon mixer 146 includes an injector plate 218 (e.g., guide, blade, louver, guide plate, etc.). The injector plate 218 is coupled to the mixer body 202 along a portion of the first aperture 214. The injector plate 218 is configured to facilitate flow of the exhaust from the outer portion of the mixer body 202 through the first aperture 214. The injector plate 218 includes an injector plate flange 220. The injector plate flange 220 is configured to couple a portion of the injector plate 218 to the mixer body 202.

The injector plate 218 includes an injector plate panel 224. The injector plate panel 224 is contiguous with the injector plate flange 220. The injector plate panel 224 is positioned such that the injector plate 218 is angled away from the mixer body at a first opening angle in a range of approximately 15° to approximately 30° (e.g., 15°, 20°, 20.5°, 25°, 30°, etc.), measured counterclockwise from the mixer body 202 to form a flow aperture 226. As used herein, angles are measured positive in a counterclockwise direction from a downstream perspective (e.g., from the outlet-side 212 looking upstream toward the inlet-side 210). The flow aperture 226 is formed between a first edge of the injector plate panel 224 and the mixer body 202 and between a second edge of the injector plate panel 224 and the mixer body 202. The flow aperture 226 is configured to facilitate flow of exhaust between the mixer body 202 and the injector plate panel 224 such that the exhaust flows through the first aperture 214 and into the mixer body cavity 216.

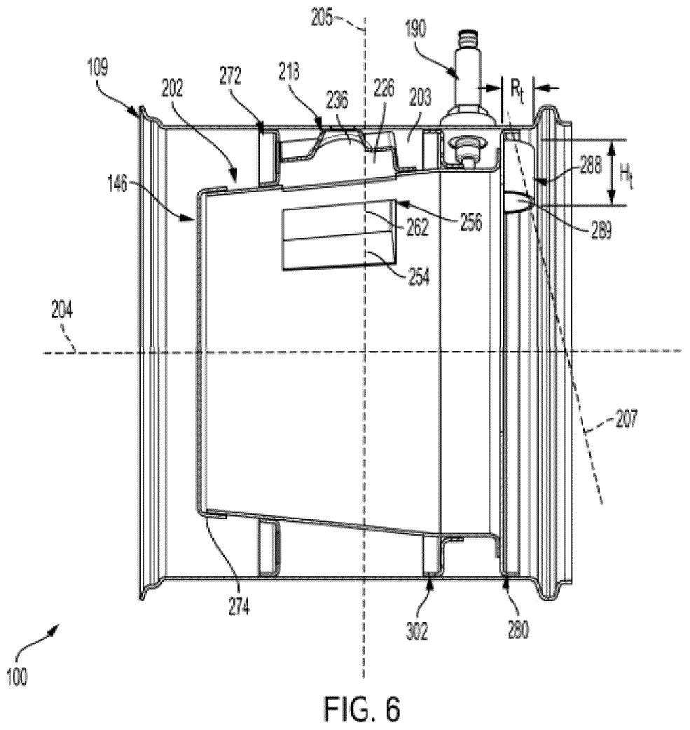

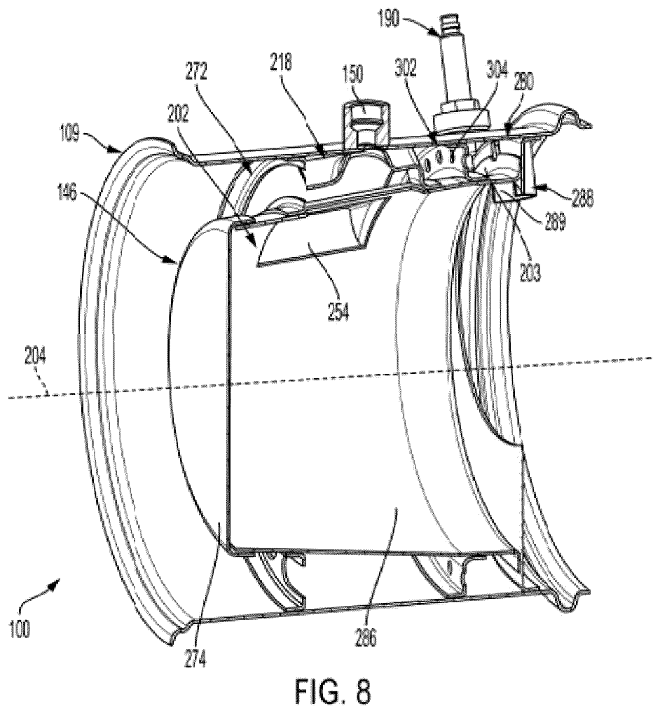

The injector plate 218 includes an injector cone 234. The injector cone 234 is positioned on the injector plate 218. The injector cone 234 includes an injection aperture 236, as depicted in FIG. 6, for example. The injection aperture 236 is configured to facilitate flow of the hydrocarbon fluid from the hydrocarbon injector 150 through the injector cone 234 and the injector plate 218 to the mixer body cavity 216, as shown in FIG. 8. For example, the hydrocarbon injector 150 injects hydrocarbon fluid through the injection aperture 236 into the mixer body cavity 216 such that the hydrocarbon fluid and the exhaust may mix. In some embodiments, the injection aperture 236 is centered on an injection axis 175 (as shown in FIG. 1, for example), which is an axis extending through the injection aperture 236. In some embodiments, the injection axis 175 may be angled away from the center of the injector cone 234.

The hydrocarbon mixer 146 incudes a second aperture 238, as depicted in FIG. 5, for example. The second aperture 238 is substantially similar to the first aperture 214 and therefore not described in further detail. The second aperture 238 is annularly adjacent to (e.g., adjacent along a circumference of the mixer body 202) the first aperture 214, such that a portion of the mixer body 202 extends annularly between the first aperture 214 and the second aperture 238 and that no other aperture is included in this portion of the mixer body 202. The hydrocarbon mixer 146 includes a first guide plate 240 (e.g., plate, louver, blade, etc.). The first guide plate 240 is coupled to the mixer body 202 along a portion of the second aperture 238. The first guide plate 240 is configured to facilitate a portion of the exhaust at the outer portion of the mixer body 202 through the second aperture 238 through the mixer body 202 and into the mixer body cavity 216.

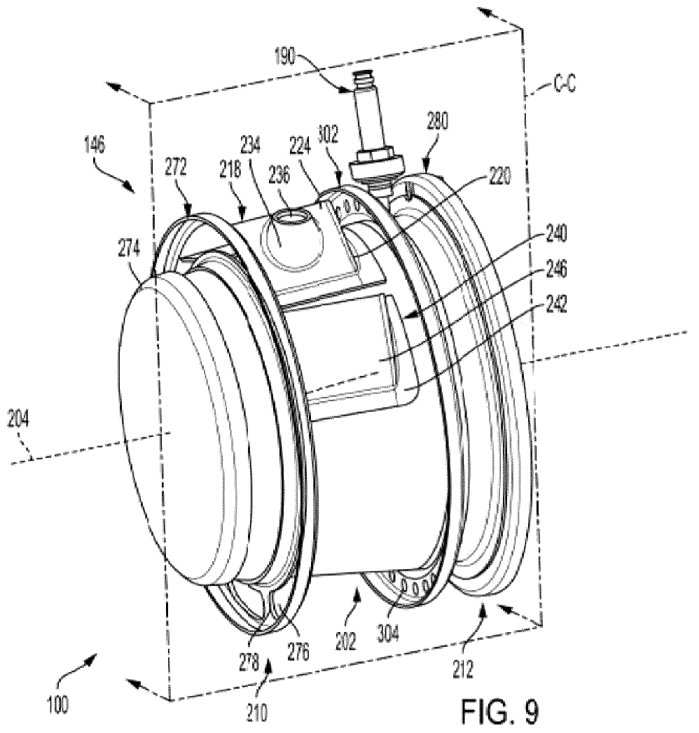

The first guide plate 240 includes a first guide plate flange 242, as depicted in FIG. 9, for example. The first guide plate first flange 242 is configured to couple a portion of the first guide plate 240 to the mixer body 202. The first guide plate 240 includes a first guide plate panel 246. The first guide plate panel 246 is contiguous with the first guide plate flange 242. The first guide plate panel 246 is positioned such that the first guide plate 240 is angled away from the mixer body at a second opening angle in a range of approximately 15° to approximately 30° (e.g., 15°, 20°, 20.5°, 22.1°, 25°, 30°, etc.) to form a first guide plate flow aperture 248. The first guide plate flow aperture 248 if formed between a first edge of the first guide plate panel 246 and the mixer body 202 and between a second edge of the first guide plate panel 246 and the mixer body 202 such that the exhaust flows through the second aperture 238 and in to mixer body cavity 216.

In some embodiments, the first guide plate 240 includes a first guide plate sidewall (not depicted separately) contiguous with the first guide plate first flange 242 and the first guide plate panel 246. The first guide plate sidewall may be configured to reduce (or, in some instances, prevent) the flow of exhaust between the first guide plate panel 246 and the first guide plate first flange 242. In some embodiments, the first guide plate sidewall is configured to guide a portion of the exhaust flowing between the first guide plate panel 246 and the mixer body 202 through the second aperture 238. In some embodiments, the first guide plate sidewall is rounded so as to facilitate swirling of the exhaust.

The hydrocarbon mixer 146 includes a third aperture 254, as depicted in FIGS. 6-8, for example. The third aperture 254 is substantially similar to the first aperture 214 and therefore not described in further detail. The third aperture 254 is annularly adjacent to the first aperture 214 and on a side of the first aperture 214 opposite to the second aperture 238, such that a portion of the mixer body 202 extends annularly between the first aperture 214 and third aperture 254 and that no other aperture is included in this portion of the mixer body 202. The hydrocarbon mixer 146 includes a second guide plate 256 (e.g., plate, louver, blade, etc.). The second guide plate 256 is substantially similar to the first guide plate 240. The second guide plate 256 includes a second guide plate flange 258 which is substantially similar to the first guide plate flange 242 and therefore not described in further detail. The second guide plate 256 includes a second guide plate panel 262 which is substantially similar to the first guide plate panel 246. The second guide plate panel 262 is positioned such that the second guide plate 256 is angled away from the mixer body at a third opening angle in a range of approximately 15° to approximately 30° (e.g., 15°, 20°, 20.5°, 22.1°, 25°, 30°, etc.) to form a second guide plate flow aperture 264. The second guide plate flow aperture 264 is substantially similar to the first guide plate flow aperture 248 and therefore not described in further detail. In some embodiments, the second guide plate 256 includes a second guide plate sidewall (not depicted separately) substantially similar to the first guide plate sidewall and therefore not described in further detail.

As shown in any of FIGS. 6, 8-12, and 14, for example, the aftertreatment system 100 includes the sensor 190 (e.g., NOₓ sensor, CO sensor, CO₂ sensor, O₂ sensor, particulate sensor, nitrogen sensor, SOₓ sensor, etc.) coupled to the mixer body 202. In some embodiments, the sensor 190 extends through a passageway 203 (e.g., a cavity; as depicted in FIGS. 6 and 8) between the introduction conduit 109 and the mixer body 202 and is positioned downstream of the injector plate 218 (and the first guide plate 240, the second guide plate 256), e.g., between the injector plate 218 and the outlet-side 212, along the mixer body center axis 204 (or the conduit axis 106). In some embodiments, the sensor 190 is positioned between two adjacent apertures in the mixer body 202 along the circumference of the mixer body 202. For example, the sensor 190 may be positioned between the first aperture 214 (e.g., the injector plate 218) and the second aperture 238 (e.g., the first guide plate 240) along the circumference of the mixer body 202. Alternatively, the sensor 190 may be positioned between the first aperture 214 (e.g., the injector plate 218) and the third aperture 254 (e.g., the second guide plate 256). In some embodiments, the sensor 190 is positioned to be offset from the injection aperture 236 along the circumference of the mixer body 202 so as to reduce the inadvertent fouling of the sensor 190 by the hydrocarbon fluid escaping through the injection aperture 236 during the injection and/or the mixing process.

The sensor 190 may be configured to measure (e.g., sense, detect, etc.) a signal associated with a parameter (e.g., NOₓ concentration, CO concentration, CO₂ concentration, O₂ concentration, particulate concentration, nitrogen concentration, SOₓ concentration, etc.) of the exhaust and/or the hydrocarbon fluid to be in mixed the mixer body cavity 216. In some embodiments, the sensor 190 is configured to measure a signal associated with the parameter of the exhaust as it enters the mixer body 202 to be mixed with the hydrocarbon fluid introduced by the hydrocarbon injector 150. In some embodiments, the parameter is the NOₓ concentration in the exhaust downstream of the upstream catalyst member 138. In some embodiments, the sensor 190 is configured to measure a signal associated with the NOₓ concentration in a portion of the exhaust flowing through the passageway 203 between the introduction conduit 109 and the mixer body 202.

As described above, the sensor 190 is electrically or communicatively coupled to the aftertreatment system controller 128, which is configured to determine a measurement based on the signal (e.g., via the aftertreatment system processing circuit 130, etc.). The aftertreatment system controller 128 may be configured to control the intake chamber dosing module 112, the dosing module 172, the reductant fluid pump 116, and/or the air pump 122 based on the signal measured by the sensor 190. Furthermore, the aftertreatment system controller 128 may be configured to communicate the signal to the central controller 136.

Referring to FIGS. 5-32, the hydrocarbon mixer 146 includes an inlet flange 272 (e.g., panel, coupler, ring, etc.). The inlet flange 272 includes an inlet flange body 274. The inlet flange body 274 is coupled to the inlet-side 210 of the mixer body 202. The inlet flange body 274 reduces (or, in some instance, prevents) exhaust from flowing directly into the mixer body cavity 216. In some embodiments, the inlet flange body 274 is also coupled to the introduction conduit 109. The inlet flange 272 functions to separate the mixer body 202 from the introduction conduit 109 and support the mixer body 202 within the introduction conduit 109.

The inlet flange 272 includes inlet flange apertures 276 (e.g., windows, holes, etc.). Each of the inlet flange apertures 276 extends through the inlet flange body 274. The inlet flange apertures 276 are arrayed (e.g., arranged, positioned, etc.) circumferentially around the inlet flange body 274. Each of the inlet flange apertures 276 is configured to facilitate flow of the exhaust through the inlet flange body 274 to the passageway 203. The passageway 203 refers to the space between the mixer body 202 and the introduction conduit 109 and configured to receive the exhaust flowing from the inlet flange apertures 276 such that the injector plate 218 facilitates a portion of the exhaust through the first aperture 214, the first guide plate 240 facilitates a portion of the exhaust through the second aperture 238 and the second guide plate facilitates a portion of the exhaust through the third aperture 254. In some embodiments, the sensor 190 is positioned to sample a portion of the exhaust flowing through the passageway 203 as described above.

In various embodiments, the inlet flange 272 includes inlet flange supports 278 (e.g., arms, bars, support structures, etc.). The inlet flange supports 278 are coupled to the inlet flange body 274 and are configured to couple the inlet flange 272 to the introduction conduit 109. In some embodiments, the inlet flange supports 278 may be integrally formed with the inlet flange body 274.

Each of the inlet flange supports 278 may define a portion of one of the inlet flange apertures 276. For example, where the inlet flange 272 includes four inlet flange supports 278, the inlet flange includes four inlet flange apertures 276 (e.g., a first inlet flange aperture 276 between a first inlet flange support 278 and a second inlet flange support 278, a second inlet flange aperture 276 between a second inlet flange support 278 and a third inlet flange support 278, a third inlet flange aperture 276 between a third inlet flange support 278 and a fourth inlet flange support 278, and a fourth inlet flange aperture 276 between a fourth inlet flange support 278 and a first inlet flange support 278). In various embodiments, a distance between each of the inlet flange supports 278 may vary. For example, the distance between a first inlet flange support 278 and a second inlet flange support 278 may be greater than the distance between the second inlet flange support 278 and the third inlet flange support 278. Consequently, the size of the first inlet flange aperture 276 may be greater than the size of the second inlet flange aperture 276, for example.

In operation, the exhaust flows from an internal engine to the intake chamber 108 (see FIG. 1 for example). The exhaust flows through the upstream components (e.g., the upstream catalyst member 138, the upstream ammonia slip catalyst substrate 144, etc.), as described herein, and through the inlet flange apertures 276. The exhaust flows toward the injector plate 218, the first guide plate 240, and the second guide plate 256. The injector plate 218 facilitates a portion of the exhaust through the first aperture 214 and into the mixer body cavity 216, as described herein. The first guide plate 240 facilitates a portion of the exhaust through the second aperture 238 and into the mixer body cavity 216, as described herein. The second guide plate 256 facilitates a portion of the exhaust through the third aperture and into the mixer body cavity 216, as described herein. The exhaust is caused to swirl within the mixer body cavity 216 so as to mix with the hydrocarbon fluid introduced by the hydrocarbon injector 150. The exhaust flows from the mixer body cavity 216 downstream toward the first oxidation catalyst member 158, for example, as shown in FIGS. 1-4.

The hydrocarbon mixer 146 further includes an outlet flange 280 (e.g., panel, coupler, ring, etc.) coupled to the outlet-side 212 of the mixer body 202 and further to the introduction conduit 109. The outlet flange 280 is centered on the mixer body center axis 204, which may coincide with the conduit axis 106. The outlet flange 280 includes an outlet flange body 284. The outlet flange body 284 is centered on the mixer body center axis 204. The outlet flange 280 include an outlet flange aperture 286. The outlet flange aperture 286 extends through the outlet flange body 284. The outlet flange aperture 286 is configured to provide the exhaust from the mixer body cavity 216 through the outlet flange 280 to downstream components (e.g., the first oxidation catalyst member 158, the upstream particulate filter 168, the mixer 170, the first downstream catalyst member 176, the second downstream catalyst member 182, and the downstream ammonia slip catalyst substrate 188, etc.). The outlet flange aperture 286 has a diameter in the range of approximately 145 mm to approximately 215 mm (e.g., 137.75 mm, 145 mm, 150 mm, 155 mm, 160 mm, 165 mm, 200 mm, 171.18 mm, 175 mm, 180 mm, 185 mm, 189 mm, 195 mm, 200 mm, 205 mm, 210 mm, 215 mm, 225.75 mm, etc.).

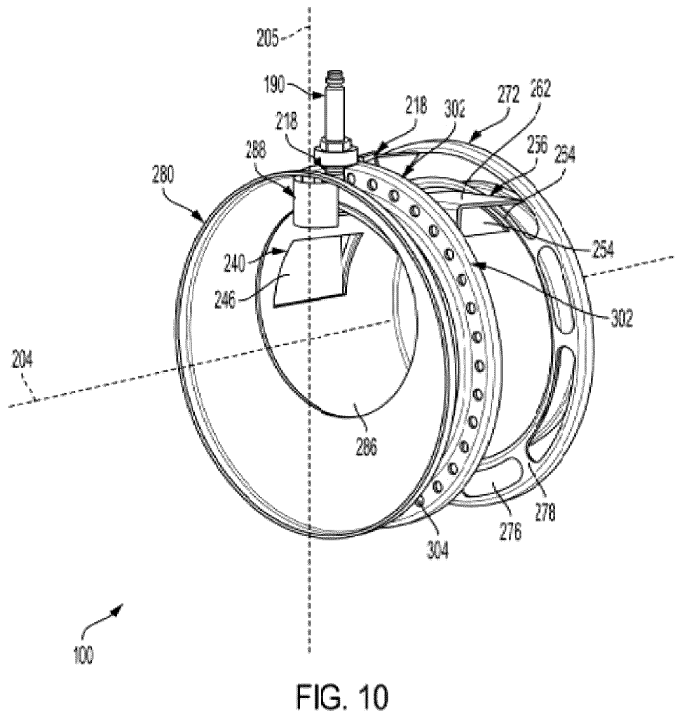

Referring to FIGS. 10 11, 15, 17, 25, and 28, for example, the outlet flange aperture 286 may be offset from the center of the outlet flange 280. By offsetting the outlet flange aperture 286 from the center of the outlet flange 280, the pressure of the exhaust flowing from the mixer body cavity 216 is reduced. In some embodiments, the outlet flange aperture 286 is centered on the mixer body center axis 204.

Referring to FIGS. 5-15, the hydrocarbon mixer 146 further includes an exhaust sampling flange 302 (e.g., panel, coupler, ring, etc.) coupled to the mixer body 202 at a location downstream of the injector plate 218 (and the first guide plate 240 and the second guide plate 256) and upstream of the sensor 190. In various embodiments, the exhaust sampling flange 302 is configured to facilitate the delivery and sampling of the exhaust downstream of the upstream catalyst member 138. Furthermore, the exhaust sampling flange 302 is configured to reduce an amount of hydrocarbon fluid being sampled at low-flow conditions.

In some embodiments, the exhaust sampling flange 302 is immediately upstream of the sensor 190, such that a separation distance between the exhaust sampling flange 302 and the sensor 190 is in the range of approximately 15 mm to approximately 25 mm (e.g., 15 mm, 16.4 mm, 17.5 mm, 18 mm, 19.6 mm, 20 mm, 22.5 mm, 23.7 mm, 24 mm, 25.3 mm, etc.). In some embodiments, the separation distance between the sensor 190 and the outlet flange 280 is in the range of approximately 15 mm to approximately 25 mm (e.g., 14.5 mm, 15.8 mm, 16.9 mm, 17.5 mm, 18.4 mm, 19 mm, 21 mm, 22.5 mm, 24.2 mm, 26 mm, etc.). In some embodiments, the separation distance between the exhaust sampling flange 302 and the sensor 190 is substantially the same as the separation distance between the sensor 190 and the outlet flange 280.

The exhaust sampling flange 302 is annular (e.g., ring-shaped) and centered on the mixer body center axis 204 (e.g., the conduit axis 106). In various embodiments, the exhaust sampling flange 302 includes perforations 304 (e.g., apertures, openings, holes, etc.) arranged in an array extending circumferentially (e.g., annularly) around the mixer body center axis 204. In various embodiments, the perforations 304 are equally, or substantially equally, spaced along a pitch circle diameter (PCD) of the exhaust sampling flange 302. In this regard, the number of the perforations 304 may vary according to the size of the exhaust sampling flange 302. For example, the exhaust sampling flange 302 may include approximately in a range of 10 of the perforations 304 and 40 of the perforations 304 (e.g., 10 of the perforations 304, 16 of the perforations 304, 22 of the perforations 304, 26 of the perforations 304, 30 of the perforations 304, 38 of the perforations 304, 40 of the perforations 304, etc.). In some examples, the PCD of the exhaust sampling flange 302 is similar to (e.g., ±3 mm) a diameter (e.g., diameter D₃ as shown in FIG. 15) of the upstream ammonia slip catalyst substrate 144 (or the first oxidation catalyst substrate 162). For example, if the diameter of the upstream ammonia slip catalyst substrate 144 is approximately 266.7 mm (e.g., approximately 10.5 in), then the PCD of the exhaust sampling flange 302 may be in a range of approximately 263.7 mm to approximately 269.7 mm (e.g., 264.1 mm, 265 mm, 266.7 mm, 268.6 mm, 269 mm, etc.).

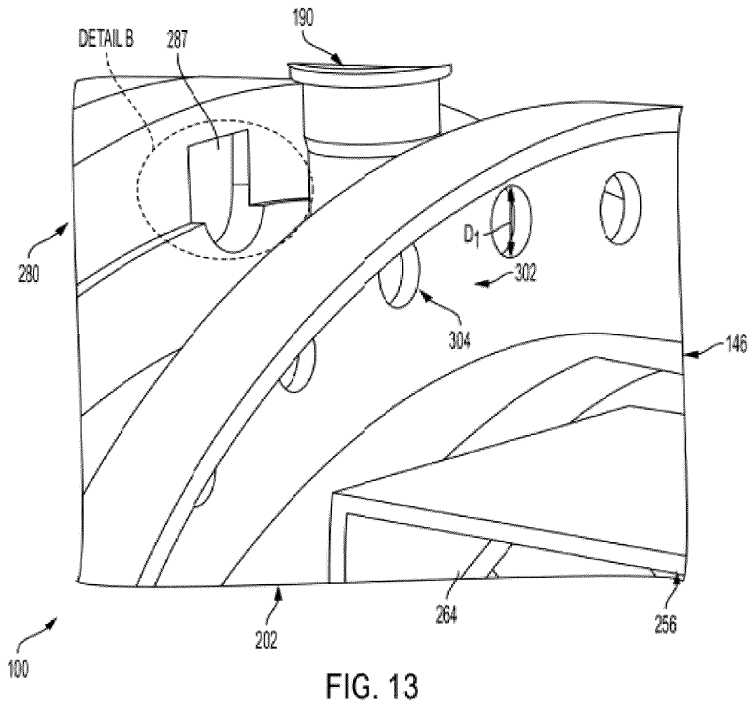

As shown in FIG. 13, the perforations 304 are substantially identical in shape (e.g., an open circular shape) and may each be defined by a diameter D₁ in a range of approximately 8 mm to approximately 12 mm (e.g., 7.6 mm, 8 mm, 8.5 mm, 9 mm, 9.3 mm, 10 mm, 11 mm, 11.5 mm, 12 mm, 12.6 mm, etc.). In this regard, an open area of each perforation 304 is in a range of approximately 45.4 mm² to approximately 124.7 mm² (e.g., 45.4 mm², 50.3 mm², 78.5 mm², 63.6 mm², 95.0 mm², 113.1 mm², 124.7 mm², etc.), which may be calculated by a formula πD₁²/4.

In some embodiments, the diameter D₁ is adjusted to meet design considerations that include, for example, reduction in backpressure of the flow of the exhaust as it is drawn through the perforations 304 and increase in velocity of the flow of the exhaust to assist in the sampling of the exhaust at low-flow conditions. On the one hand, reducing the diameter D₁ to below the range described herein may result in the exhaust passing through the perforations 304 at a lower velocity, thereby reducing the velocity of the flow as it reaches the sensor 190. On the other hand, enlarging the diameter D₁ to above the range described herein without reducing the number of perforations 304 may lead to an increased amount of the exhaust being drawn through the perforations 304, thereby impacting (e.g., reducing) the distribution and swirling of the exhaust within the mixer body cavity 216 and the subsequent mixing of the exhaust with the hydrocarbon fluid. Accordingly, it may be desirable to enlarge the size and reduce the number of the perforations 304 so as to increase the velocity of the flow while maintaining its distribution and reducing the bypassing of the exhaust from the mixer body cavity 216.

In some embodiments, though not depicted, the exhaust sampling flange 302 further includes a slot (e.g., elongated opening, extended aperture, etc.) extending through the exhaust sampling flange 302. The slot may have an elongated shape conforming to a curvature of the exhaust sampling flange 302. The slot may be defined by a height along a first direction radially extending away from the mixer body center axis 204 and a length along a second direction along the circumference of the exhaust sampling flange 302. The length of the slot is significantly greater than the height of the slot. For example, the length may be approximately in the range of 8 to 12 times the width. In contrast, the perforations 304 each have a substantially circular shape, which is defined by the diameter D₁. Assuming the width of the slot is substantially similar to the diameter D₁, each slot is configured with an open area that is greater than that of each perforation 304. For example, each slot may have an open area that is approximately in the range of 6 to 12 times larger than the open area of each perforation 304.

In some embodiments, the exhaust sampling flange 302 includes multiple slots but none of the perforations 304. In some embodiments, the exhaust sampling flange 302 includes one slot among a plurality of perforations 304, where the slot is aligned with the sensor 190 along the mixer body center axis 204 such that it exposes the sensor 190 to the flow of the exhaust upstream of the exhaust sampling flange 302. In some embodiments, the slot(s) provides at least the benefit of reducing the backpressure of the flow of exhaust in the passageway 203. Additionally, if the slot is aligned with the sensor 190, the flow of the exhaust provided to the sensor 190 may be increased, potentially improving the accuracy of the results of sampling.

The perforations 304 (and the slots, if included) are configured to facilitate the flow of the exhaust downstream from the upstream catalyst member 138, such that a sampling portion (e.g., a first portion) of the exhaust within the passageway 203 between the introduction conduit 109 and the mixer body 202 can be provided to the sensor 190 for measurement, while the remaining portion of the exhaust is drawn into the mixer body 202 through one or more of the first aperture 214, the second aperture 238, the third aperture 254, or other similar apertures on the mixer body 202 to be mixed with the hydrocarbon fluid.

Under low-flow boundary conditions, uneven flow distribution and low flow velocity may cause the hydrocarbon fluid injected into the mixer body cavity 216 to not break properly and/or mix thoroughly with the exhaust in the mixer body cavity 216. This may lead to particles of the hydrocarbon fluid escaping from the mixer body cavity 216 through one or more of the first aperture 214, the second aperture 238, the third aperture 254, or other similar apertures on the mixer body 202 and inadvertently striking the sensor 190. In some instances, when heated particles of the hydrocarbon fluid escape from the mixer body cavity 216 and strike the sensor 190, which may be configured to measure a signal associated with the NOₓ concentration, the sensor 190 may undergo thermal shock, leading to potential sensor failure. In some instances, the sensor 190 may also be cross-sensitive to components (e.g., oxygen) of the hydrocarbon fluid, which may result in poor sensing accuracy. For example, fouling of the sensor 190 by particles of the hydrocarbon fluid may lead to an overestimation of the amount of NOₓ present in the exhaust.

The perforations 304 are configured to increase the velocity of and/or to evenly distribute the sampling portion of the exhaust as it flows through the passageway 203 toward the sensor 190. In various embodiments, the exhaust sampling flange 302 is configured to direct the sampling portion of the exhaust toward the sensor 190 without, or substantially without, drawing in the hydrocarbon fluid, thereby reducing potential sensor failure caused by the hydrocarbon fluid and mitigating cross-sensitivity of the sensor 190 to components of the hydrocarbon fluid (and not the NOₓ in the exhaust, for example).

In some embodiments, the increase in velocity and/or even distribution of the exhaust varies according to size (e.g., the open area of each perforation 304) and/or distribution of the perforations 304. For example, as discussed above, increasing the diameter D₁ increases the velocity of the flow of the exhaust received by the sensor 190 for better sampling results, especially at low-flow boundary conditions. In addition, increasing the velocity and/or the distribution of the flow of the exhaust may improve the sensing accuracy, as it reduces an amount of the particles of the hydrocarbon fluid that would otherwise contribute to the signal of the sensor detected due to the sensor's cross-sensitivity to components of the hydrocarbon fluid.

In some embodiments, the perforations 304 are evenly distributed around the circumference of the mixer body 202 such that a separation distance between any two adjacent perforations 304 is substantially constant. Even distribution of the perforations 304 may lead to an even distribution of the flow of the exhaust being sampled by the sensor 190. In some embodiments, the perforations 304 are not evenly distributed. For example, a first separation distance between a first perforation 304 and a second perforation 304 is greater than a second separation distance between the second perforation 304 and a third perforation 304.

In some embodiments, at least one of the perforations 304 is aligned with one of the first guide plate 240 and the second guide plate 256 along the mixer body center axis 204. As the mixer body cavity 216 receives the exhaust through one or more of the apertures (e.g., the first aperture 214, the second aperture 238, the third aperture 254, and other similar apertures) on the mixer body 202, by aligning at least one of the perforations 304 with one of the first guide plate 240 and the second guide plate 256 along the mixer body center axis 204, which each include a guide plate panel that extends over the second aperture 238 and the third aperture 254, respectively, the flow of the exhaust passing through the at least one of the perforations 304 may be maximized to improve the signal measured by the sensor 190, thereby enhancing the results of the sampling. In some embodiments, the perforations 304 are distributed in such a way that one of the perforations 304 is aligned with the sensor 190 along the mixer body center axis 204 (e.g., the conduit axis 106). In this regard, such a perforation 304 allows the exhaust to directly flow downstream through the exhaust sampling flange 302, thereby maximizing the sampling portion of the exhaust provided to the sensor 190 for measurement.

At low-flow conditions (e.g., when the exhaust exhibit lower velocity at or below 1 mL/s), particles of the hydrocarbon fluid may exhibit higher momentum than the exhaust, which may cause the particles to escape from the mixer body cavity 216 through or near the injection aperture 236 (e.g., where the particles have higher momentum) on the injector plate 218 during the injection process, and be drawn through one or more of the perforations 304 to be sampled by the sensor 190, leading to inadvertent fouling of the sensor 190. Accordingly, the perforations 304 are arranged and positioned such that each of the perforations 304 is offset from the injector plate 218 that includes the injection aperture 236 along the mixer body center axis 204. This offset may mitigate (e.g., reduce) the particles of the hydrocarbon fluid from being mixed into the flow of the exhaust, a portion (e.g., the sampling portion) of which is subsequently drawn through the perforations 304 before being sampled by the sensor 190, thereby reducing fouling of the sampling portion of the exhaust provided to the sensor 190. In some embodiments, the injector plate 218 is aligned with a portion of the exhaust sampling flange 302 between two adjacent perforations 304 along the mixer body center axis 204, such that the injector plate 218 is offset from each of the two perforations 304. In this regard, the exhaust sampling flange 302 serves as a barrier between the injector plate 218 and the sensor 190, such that the particles of the hydrocarbon fluid may be blocked by the portion of the exhaust sampling flange 302 between two adjacent perforations 304.

Additionally or alternatively, the injector plate 218 may be positioned above (e.g., vertically protrude from) an upper edge of the exhaust sampling flange 302 (e.g., over the perforations 304) or below a lower edge of the exhaust sampling flange 302 (e.g., under the perforations 304), such that the injector plate 218 is offset from the perforations 304 along an axis 205 (as depicted in FIGS. 6 and 10) perpendicular to the mixer body center axis 204. In this regard, the sampling portion of the flow of the exhaust is drawn through the perforations 304 along a path that is over or under a path along which particles of the hydrocarbon fluid may travel, resulting in a lower probability of the particles being incorporated into the sampling portion of the flow of the exhaust. Similarly, the sensor 190 is also positioned to be offset from the injector plate 218 along the mixer body center axis 204 to mitigate accidental fouling of the sensor 190 during the injection process.

As shown in FIGS. 6, 8, 10, and 12-14, for example, the hydrocarbon mixer 146 further includes an outlet tube 288 (e.g., outlet member, tubular opening, tubular outlet, etc.) coupled to the outlet flange 280 through an opening 287 (e.g., aperture, cavity, etc.) in the outlet flange 280. The outlet tube 288 surrounds a cavity 289 (e.g., aperture, opening, etc.) that extends into the outlet flange aperture 286. The outlet tube 288 is positioned immediately downstream of the sensor 190 to be in fluid communication with at least one of the perforations 304, which completes the path for the flow of the sampling portion of the exhaust out of the hydrocarbon mixer 146. In various embodiments, the opening 287 constricts the flow of the exhaust, thereby drawing the sampling portion of the exhaust from a high-pressure area (e.g., upstream of the exhaust sampling flange 302) to a low-pressure area (e.g., downstream of the outlet flange 280) across the sensor 190. As such, the sampling portion of the exhaust flows through the outlet tube 288 (e.g., into the outlet flange aperture 286) at an increased velocity (e.g., consistent with the Venturi effect) toward downstream components of the aftertreatment system 100 (e.g., the first oxidation catalyst member 158, the upstream particulate filter 168, the mixer 170, the first downstream catalyst member 176, the second downstream catalyst member 182, and the downstream ammonia slip catalyst substrate 188, etc.).

In some embodiments, the outlet tube 288 is defined by a semicircular shape from a bottom (or a top) view as shown in FIG. 6. The semicircular shape may be defined by a radius Rt (e.g., a first dimension) that extends along the mixer body center axis 204 (e.g., the conduit axis 106) and a height Hₜ (e.g., a second dimension) that extends along the axis 205, where the height Hₜ may be greater than the radius Rt. The radius Rt may be in a range of approximately 10 mm to approximately 30 mm (e.g., 9.5 mm, 12.7 mm, 14 mm, 15.5 mm, 17.2 mm, 21 mm, 23.3 mm, 26 mm, 28 mm, 31.5 mm, etc.). The height Hₜ may be in a range of approximately 15 mm to approximately 40 mm (e.g., 14.5 mm, 16 mm, 20.5 mm, 22 mm, 25.6 mm, 28 mm, 32.3 mm, 36 mm, 39.5 mm, 42 mm, etc.). In some embodiments, the outlet tube 288 may be configured as other suitable shapes, such as a circular tube having a radius similar to or different from the radius Rt.

In some embodiments, a first portion (e.g., a top portion) of the outlet tube 288 is coupled to the outlet flange 280, while a second portion (e.g., a bottom portion) of the outlet tube 288 extends along the axis 205 into and suspends over the outlet flange aperture 286. As shown in FIGS. 6 and 10, the outlet tube 288 is elongated along the axis 205 to extend into (e.g., partially overlap with) the outlet flange aperture 286, such that the sampling portion of the exhaust may be directed by the outlet tube 288 to combine with the treated exhaust from the mixer body cavity 216 before flowing downstream. In some embodiments, though not depicted, the outlet tube 288 is oriented height-wise along an axis 207 (as depicted in FIG. 6) that is slanted away from the axis 205. The height H₁ being oriented along the axis 205 may assist in the directional drawing of the flow of the exhaust through the cavity 289 and directly into the outlet flange aperture 286, while the height H₁ being oriented along the axis 207 may assist in the directional drawing of the flow of the exhaust directly toward the downstream components of the aftertreatment system 100.

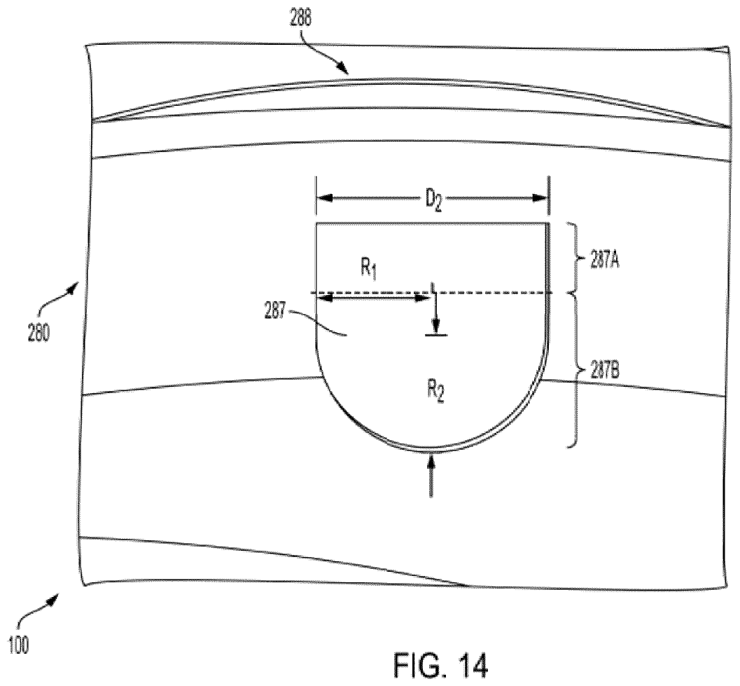

Referring to FIGS. 13 and 14, the opening 287 in the outlet flange 280 allows the sampling portion of the exhaust to flow into the outlet flange aperture 286 after being sampled by the sensor 190. A front view of the opening 287 from the upstream perspective shows that the opening 287 may be defined by a top portion 287A over a bottom portion 287B. The top portion 287A may be defined by a width D₂, and the bottom portion 287B may be defined by a radius R₁ extending in the direction of the width D₂ and a radius R₂ extending in a direction perpendicular to the width D₂. In some embodiments, the radius R₁ is the same as the radius R₂. In some embodiments, the width D₂ is greater than each of the radius R₁ and the radius R₂. For example, the width D₂ may be equal to a sum of the radius R₁ and the radius R₂. In an example embodiment, the width D₂ may be approximately 12.7 mm (e.g., 12.07 mm, 12.2 mm, 12.35 mm, 12.47 mm, 12.5 mm, 12.68 mm, etc.), and R₁ and R₂ may each be approximately 6.35 mm (e.g., 6.03 mm, 6.2 mm, 6.25 mm, 6.38 mm, 6.5 mm, 6.67 mm, etc.).

As shown in FIG. 15, the upstream ammonia slip catalyst substrate 144 and the first oxidation catalyst substrate 162 may each be defined by a diameter D₃; the mixer body first plane 206 at the inlet-side 210 may be defined by a diameter D₄; the mixer body second plane 208 at the outlet-side 212 may be defined by a diameter D₅; and the outlet flange aperture 286 may be defined by a diameter D₆. In some embodiments, the diameter D₃ is greater than each of the diameters D₄, D₅, and D₆. For example, a ratio of the diameter D₃ to the diameter D₄ may be approximately 1.29; a ratio of the diameter D₃ to the diameter D₅ may be approximately 1.11; and a ratio of the diameter D₃ to the diameter D₆ may be approximately 1.55. In some examples, the diameter D₃ may be in the range of approximately 253.36 mm to approximately 280.04 mm (e.g., 253.45 mm, 255 mm, 258.3 mm, 260 mm, 266.72 mm, 275 mm, 280 mm, etc.). The diameter D₄ may be in the range of approximately 195.91 mm to approximately 216.53 mm (e.g., 196.5 mm, 200 mm, 207.34 mm, 210.4 mm, 215 mm, 215.75 mm, 216 mm, etc.). The diameter D₅ may be in the range of approximately 227 mm to approximately 251 mm (e.g., 227.2 mm, 234.5 mm, 240 mm, 245 mm, 248.3 mm, 250 mm, 251 mm, etc.). The diameter D₆ may be in the range of approximately 162.62 mm to approximately 179.74 mm (e.g., 162.6 mm, 165 mm, 168.3 mm, 172.1 mm, 177 mm, 179.7 mm, etc.).

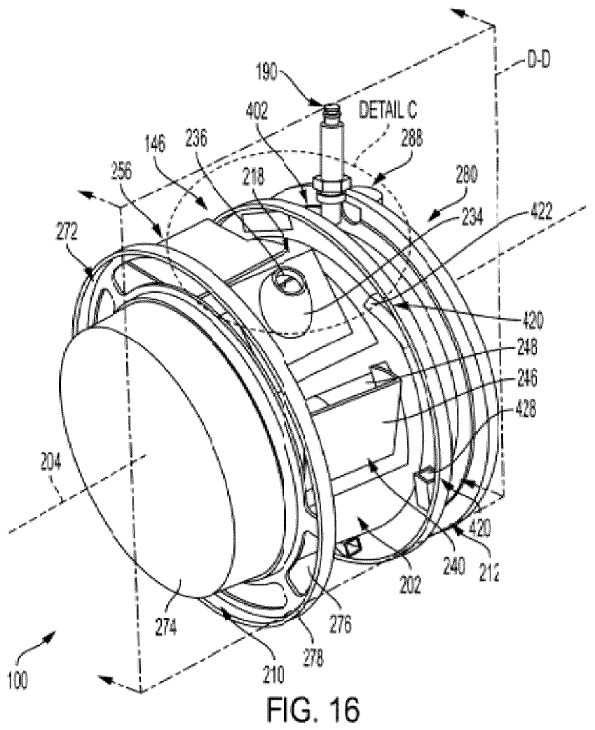

Referring to FIGS. 16-26, in some embodiments, instead of the exhaust sampling flange 302, the hydrocarbon mixer 146 includes an exhaust sampling flange 402 (e.g., panel, coupler, ring, etc.) coupled to the mixer body 202, according to one embodiment. The exhaust sampling flange 402 is similar to the exhaust sampling flange 302 in that they are both configured to assist the delivery and sampling of the exhaust downstream of the upstream catalyst member 138.

For example, the exhaust sampling flange 402, an annular (e.g., ring-shaped) structure traversing around a circumference of the mixer body 202 and centered about the mixer body center axis 204 (e.g., the conduit axis 106), is coupled to the mixer body 202 at a location between the inlet flange 272 and the outlet flange 280 along the mixer body center axis 204 (e.g., the conduit axis 106). In particular, exhaust sampling flange 402 is positioned downstream of the injector plate 218 (and the first guide plate 240 and the second guide plate 256) and upstream of the sensor 190, such that the sampling portion of the exhaust flowing downstream of the inlet flange 272 can be provided to the sensor 190 through the exhaust sampling flange 402. Furthermore, the outlet tube 288 coupled to the outlet flange 280 and positioned downstream of the sensor 190 is configured to draw the flow of exhaust across the passageway 203 between the introduction conduit 109 and the mixer body 202 to be sampled by the sensor 190 and into the outlet flange aperture 286.

In some embodiments, the relative position between the exhaust sampling flange 402 and the sensor 190 is similar to that between the exhaust sampling flange 302 and the sensor 190. For example, a separation distance between the exhaust sampling flange 402 and the sensor 190 is in a range of approximately 15 mm to approximately 25 mm (e.g., 15 mm, 16.4 mm, 17.5 mm, 18 mm, 19.6 mm, 20 mm, 22.5 mm, 23.7 mm, 24 mm, 25.3 mm, etc.). In some embodiments, a separation distance between the sensor 190 and the outlet flange 280 is in a range of approximately 15 mm to approximately 25 mm (e.g., 14.5 mm, 15.8 mm, 16.9 mm, 17.5 mm, 18.4 mm, 19 mm, 21 mm, 22.5 mm, 24.2 mm, 26 mm, etc.). In some embodiments, the separation distance between the exhaust sampling flange 402 and the sensor 190 is substantially the same as the separation distance between the sensor 190 and the outlet flange 280.

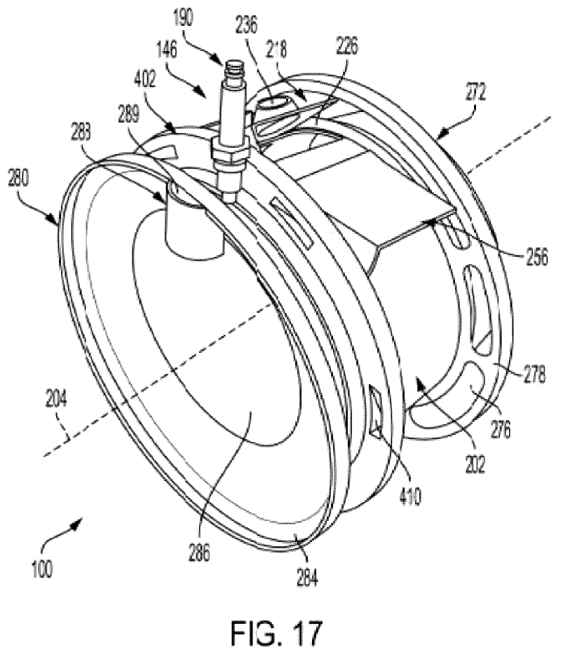

Distinct from the exhaust sampling flange 302, the exhaust sampling flange 402 relies on a different flange structure to facilitate the flow of the exhaust across the sensor 190. In various embodiments, referring to FIG. 17, the exhaust sampling flange 402 includes exhaust sampling flange apertures 410 (e.g., openings, holes, slots, etc.) through the exhaust sampling flange 402 and arranged in an array extending circumferentially around the mixer body center axis 204. The exhaust sampling flange apertures 410 may include in a range of 1 of the exhaust sampling flange apertures 410 and 10 of exhaust sampling flange apertures 410 (e.g., 1 of the exhaust sampling flange apertures 410, 2 of the exhaust sampling flange apertures 410, 3 of the exhaust sampling flange apertures 410, 6 of the exhaust sampling flange apertures 410, 8 of the exhaust sampling flange apertures 410, 10 of the exhaust sampling flange apertures 410, etc.). In an example embodiment, the exhaust sampling flange 402 includes 4 of the exhaust sampling flange apertures 410 to 8 of the exhaust sampling flange apertures 410 (e.g., 4 of the exhaust sampling flange apertures 410, 7 of the exhaust sampling flange apertures 410, 8 of the exhaust sampling flange apertures 410, etc.). In various embodiments, the exhaust sampling flange apertures 410 are substantially identical in shape and dimension. In some embodiments, an open area of the total number of the exhaust sampling flange apertures 410 is in a range of approximately 1410 mm² to approximately 3000 mm² (e.g., 1460 mm², 1500 mm², 1840.6 mm², 2000 mm², 2200.5 mm², 2560 mm², 2710.2 mm², 3100 mm², etc.).

Each of the exhaust sampling flange apertures 410 is configured to receive a portion of the exhaust flowing downstream from the upstream catalyst member 138, such that the sampling portion of the exhaust within the passageway 203 between the introduction conduit 109 and the mixer body 202 can be provided to the sensor 190 for measurement, while the remaining portion of the exhaust is drawn into the mixer body 202 through one or more of the apertures on the mixer body 202 (e.g., first aperture 214, the second aperture 238, the third aperture 254, etc.) to be mixed with the hydrocarbon fluid.

Referring to FIGS. 16 and 19-21, the exhaust sampling flange 402 includes louvers 420 (e.g., guides, blades, plates, guide plates, etc.) each having a position corresponding to that of an exhaust sampling flange aperture 410. In this regard, a number of the louvers 420 is consistent with the number of the exhaust sampling flange apertures 410. For example, the exhaust sampling flange 402 may include six exhaust sampling flange apertures 410 and six corresponding louvers 420.

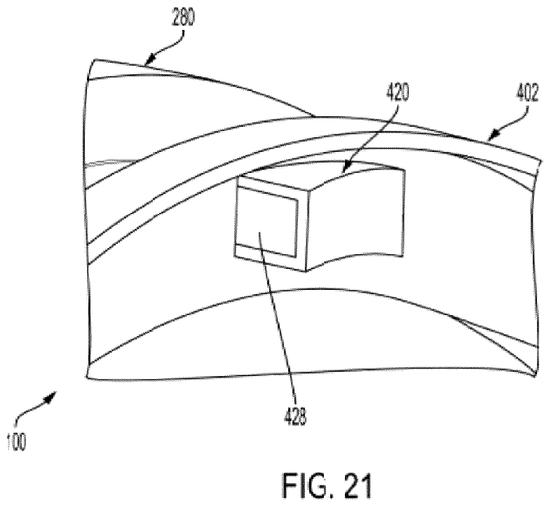

Each of the louvers 420 includes a louver panel 422 that extends over at least a portion of the corresponding exhaust sampling flange aperture 410. Each of the louver panels 422 is angled away from the exhaust sampling flange 402 and contiguous with a pair of louver sidewalls 426. The angled louver panel 422 and the pair of the louver sidewalls 426 together define a louver aperture 428, which receives the flow of the sampling portion of the exhaust from the downstream of the inlet flange 272. Such portion of the exhaust is subsequently provided to the sensor 190 for measurement through the exhaust sampling flange aperture 410. The louver panel 422 is angled in a range of approximately 15° to approximately 45° (e.g., 14.5°, 17°, 19.5°, 23°, 30.5°, 46°, etc.) with respect to the mixer body center axis 204. In some embodiments, referring to FIG. 21, an open area of each louver aperture 428 is in a range of approximately 98.50 mm² to approximately 108.87 mm² (e.g., 98.65 mm², 99.4, mm², 102 mm², 104.5 mm², 107 mm², 108.85 mm², etc.). In some embodiments, the louver aperture 428 is defined by a perimeter in a range of approximately 39.05 mm to approximately 43.16 mm (e.g., 39.22 mm, 40.5 mm, 41.0 mm, 42.5 mm, 43.0 mm, 43.15 mm, etc.).

In various embodiments, the angling of each louver panel 422 causes the sampling portion of the exhaust to swirl in a rotational direction with respect to the mixer body center axis 204 (e.g., the conduit axis 106), while facilitating the flow of the sampling portion of the exhaust through the exhaust sampling flange apertures 410. Consequently, the louvers 420 may assist in reducing backpressure of the exhaust as the exhaust flows through the exhaust sampling flange 402. In some embodiments, the louver panels 422 are angled in the same rotational direction with respect to the mixer body center axis 204 (e.g., the conduit axis 106). For example, as shown in FIGS. 16, 17, and 19, each of the louver panels 422 is angled in a counterclockwise direction with respect to the mixer body center axis 204 when viewed from the upstream perspective (e.g., from the inlet-side 210 looking downstream toward the outlet-side 212), resulting the exhaust to swirl in the counterclockwise direction. Alternatively, each of the louver panels 422 may be angled in a clockwise direction with respect to the mixer body center axis 204 when viewed from the upstream perspective, resulting in the exhaust to swirl in the clockwise direction. In some embodiments, each of the louver panel 422 is angled in the same rotational direction as the injector plate 218, the first guide plate 240, and the second guide plate 256. The size (e.g., the open area) of each louver aperture 428 influences the velocity and the extent of swirling of the flow of the exhaust through each exhaust sampling flange aperture 410, where the velocity and the extent of swirling increase when the size of each of the louver apertures 428 increases for similar reasons to those discussed herein with respect to the size of the perforations 304.

In some embodiments, at least one of the exhaust sampling flange apertures 410, which each corresponds to one of the louvers 420, is aligned with one of the first guide plate 240 and the second guide plate 256 along the mixer body center axis 204. Similar to the discussion above with respect to the perforations 304, by aligning at least one of the louvers 420 with one of the first guide plate 240 and the second guide plate 256 along the mixer body center axis 204, the flow of the exhaust passing through the at least one of the louvers 420 may be maximized to improve the signal measured by the sensor 190, thereby enhancing the results of the sampling. In some embodiments, to reduce disruption to the mixing of the hydrocarbon fluid within the mixer body cavity 216, each of the exhaust sampling flange apertures 410, which corresponds to each of the louvers 420, is offset from the injector plate 218 (e.g., the injection aperture 236) along the mixer body center axis 204.

In some embodiments, the sensor 190 is positioned between two annularly adjacent (e.g., adjacent along the circumference of the mixer body 202) louvers 420 (e.g., two adjacent exhaust sampling flange apertures 410). In some embodiments, the sensor 190 is positioned between the injector plate 218 and an adjacent guide plate (e.g., the first guide plate 240 or the second guide plate 256).

The hydrocarbon mixer 146 further includes the outlet tube 288 coupled to the outlet flange 280 through an opening 430 (e.g., aperture, cavity, hole, etc.), which is substantially similar in structure and function to the opening 287, in the outlet flange 280. Details of the outlet tube 288 have been described above. For example, the outlet tube 288 surrounds the cavity 289 that extends into the outlet flange aperture 286. The outlet tube 288 is positioned immediately downstream of the sensor 190 to be in fluid communication with at least one of the exhaust sampling flange apertures 410, thereby completing the path for the flow of the exhaust out of the hydrocarbon mixer 146. The constriction of the flow of the exhaust through the opening 430 draws the exhaust from a high-pressure area (e.g., upstream of the exhaust sampling flange 402) to a low-pressure area (e.g., downstream of the outlet flange 280) across the sensor 190, leading to an increased velocity as the exhaust exits the hydrocarbon mixer 146 toward the downstream components of the aftertreatment system 100 (e.g., the first oxidation catalyst member 158, the upstream particulate filter 168, the mixer 170, the first downstream catalyst member 176, the second downstream catalyst member 182, the downstream ammonia slip catalyst substrate 188, etc.). In various embodiments, the exhaust sampling flange apertures 410 and the louvers 420 on the exhaust sampling flange 402 provide the hydrocarbon mixer 146 with at least the benefit of increasing the velocity and the swirling of the sampling portion of the exhaust provided to the sensor 190 at low-flow conditions.

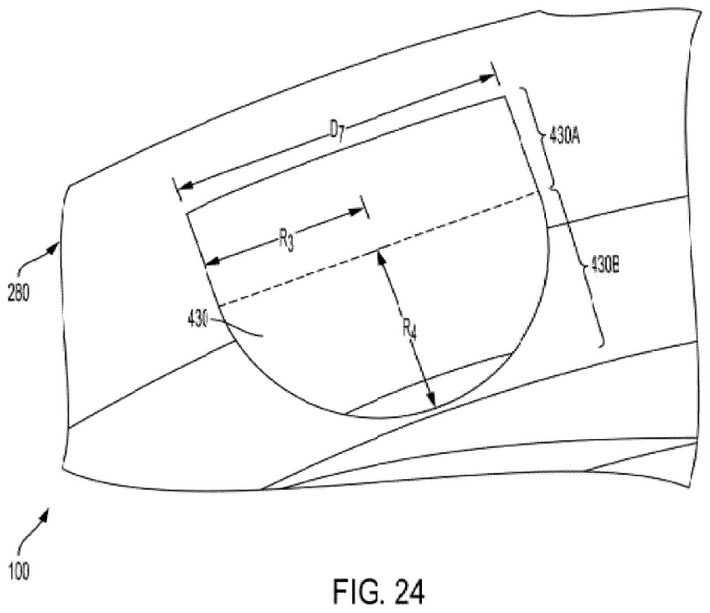

Referring to FIG. 24, a front view of the opening 430 from the upstream perspective shows that the opening 430 may be defined by a top portion 430A over a bottom portion 430B. The top portion 430A may be defined by a width D₇, and the bottom portion 430B may be defined by a radius R₃ extending in the direction of the width D₇ and a radius R₄ extending in a direction perpendicular to the direction of the width D₇. In some embodiments, the radius R₃ is the same as the radius R₄. In some embodiments, the width D₇ is greater than the radius R₃ and the radius R₄, e.g., the width D₇ is a sum of the radius R₃ and the radius R₄. In an example embodiment, the width D₇ may be approximately 20.5 mm (e.g., 19.5 mm, 19.58 mm, 19.65 mm, 19.8 mm, 19.93 mm, 21 mm, 21.5 mm, etc.), and R₃ and R₄ may each be approximately 10.25 mm (e.g., 9.74 mm, 9.5 mm, 9.62 mm, 9.7 mm, 9.95 mm, 10 mm, 10.7 mm, 10.8 mm, etc.).

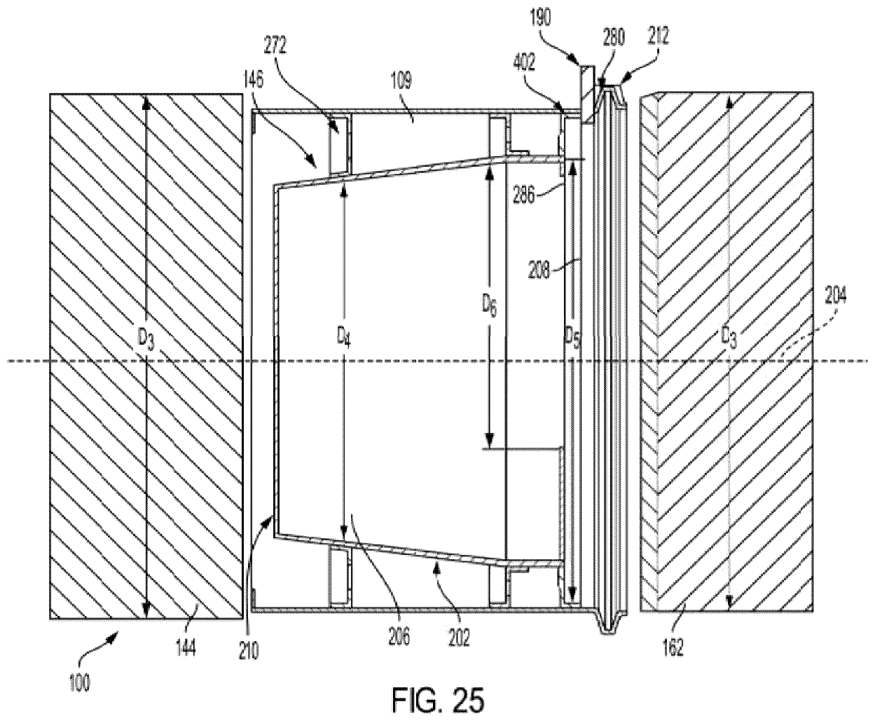

As shown in FIG. 25, various dimensions of the hydrocarbon mixer 146, which includes the exhaust sampling flange 402, the upstream ammonia slip catalyst substrate 144, and the first oxidation catalyst substrate 162 are substantially similar to those depicted in FIG. 15 in which the hydrocarbon mixer 146 includes the exhaust sampling flange 302.

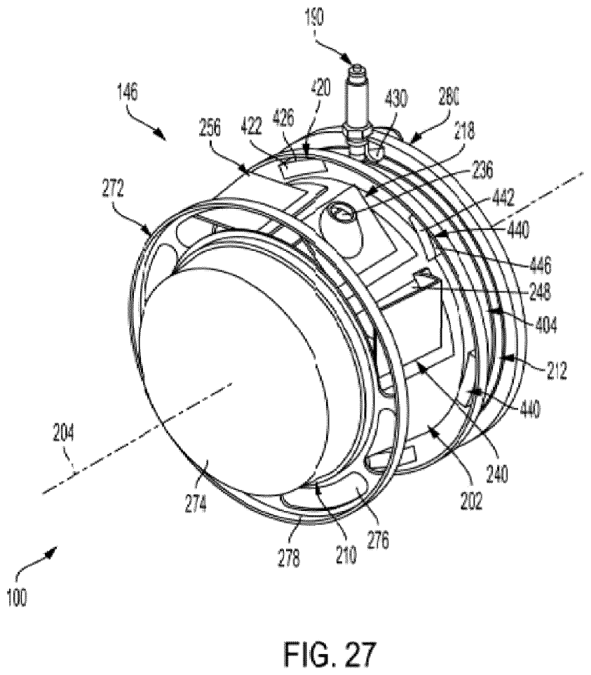

Referring to FIGS. 27-32, the hydrocarbon mixer 146 includes an exhaust sampling flange 404 (e.g., panel, coupler, ring, etc.), instead of the exhaust sampling flange 402, coupled to the mixer body 202, according to one embodiment. The exhaust sampling flange 404 is substantially similar to the exhaust sampling flange 402. In this regard, components of the exhaust sampling flange 404 that are substantially similar to or the same as those of the exhaust sampling flange 402 are described using the same reference numerals for purposes of clarity.

For example, the exhaust sampling flange 404 is positioned downstream of the injector plate 218 (and the first guide plate 240 and the second guide plate 256) and upstream of the sensor 190. In various embodiments, the exhaust sampling flange 404 includes the exhaust sampling flange apertures 410 arranged in the array that extends circumferentially around the exhaust sampling flange 404.

The exhaust sampling flange 404 includes the louvers 420, similar to those of the exhaust sampling flange 402 described above. For example, the louvers 420 extend circumferentially around the exhaust sampling flange 402 to correspond to some of the exhaust sampling flange apertures 410, and each louver 420 includes the louver panel 422 that extends over at least a portion of their corresponding exhaust sampling flange aperture 410. The louver panels 422 are each angled away from the exhaust sampling flange 404 and contiguous with the pair of louver sidewalls 426. Each louver panel 422 and the pair of louver sidewalls 426 define the louver aperture 428. The louvers 420 are angled in the same rotational direction (e.g., clockwise or counterclockwise) with respect to the mixer body center axis 204 (or the conduit axis 106) when viewed from the upstream perspective. As shown in FIGS. 27, 30, and 31, the louvers 420 are angled in the counterclockwise direction when viewed from the upstream perspective (e.g., from the inlet-side 210 looking downstream toward the outlet-side 212), similar to the depiction of the louvers 420 in FIGS. 16-21, for example.

However, different from the exhaust sampling flange 402, the exhaust sampling flange 404 further includes louvers 440 corresponding to the remainder of the exhaust sampling flange apertures 410. Each louver 440 includes a louver panel 442 extending over their corresponding exhaust sampling flange aperture 410. Each louver 440 further includes a pair of louver sidewalls 446 that form a louver aperture (not depicted) with the louver panel 442, as depicted in FIG. 27, for example. In various embodiments, the louver panels 442 are angled away from the exhaust sampling flange 404 in the same rotational direction (e.g., clockwise or counterclockwise) with respect to the mixer body center axis 204 (e.g., the conduit axis 106) when viewed from the upstream perspective. However, the louver panels 442 are angled in a rotational direction opposite to the louver panels 422 when viewed from the upstream perspective (e.g., from the inlet-side 210 looking downstream toward the outlet-side 212). For example, the louver panels 422 as shown are oriented in the counterclockwise direction and the louver panels 442 are oriented in the clockwise direction. The oppositely-oriented louvers 420 and 440 may provide at least the benefit of improving (e.g., maximizing) the flow and the distribution (by swirling, for example) of the exhaust provided to the sensor 190 through the exhaust sampling flange 404. In some instances, the louvers 420 and 440 arranged herein may also improve the overall flow distribution index (FDI) at the inlet of the first oxidation catalyst member 158. In some embodiments, the louvers 420 are positioned adjacent to one another to form a first group of louvers and the louvers 440 are positioned adjacent to one another to form a second group of louvers adjacent to the first group of louvers.

In some embodiments, the exhaust sampling flange 404 includes the same number of the louvers 420 as the louvers 440. Having the same number of the louvers 420 and the louvers 440 can help generate the same amount of swirling of the exhaust in opposite directions (e.g., symmetric swirling), thereby improving and/or maintaining the even distribution of the flow of the exhaust through the exhaust sampling flange 404. Similar to the arrangement of the louvers 420 included in the exhaust sampling flange 402, at least one of the louvers 420 and the louvers 440 is aligned with one of the first guide plate 240 and the second guide plate 256 along the mixer body center axis 204. In some embodiments, the sensor 190 is positioned between two adjacent louvers 420 and/or 440 (e.g., two adjacent exhaust sampling flange apertures 410) along the circumference of the mixer body 202. In some embodiments, to reduce disruption to the mixing of the hydrocarbon fluid provided through the injection aperture 236, each of the louvers 420 and 440 (e.g., each of the exhaust sampling flange apertures 410) is offset from the injector plate 218 along the mixer body center axis 204. For example, the injector plate 218 may be positioned between the sensor 190 and an adjacent louver 420 or 440 (e.g. an adjacent exhaust sampling flange aperture 410), and the sensor 190 may be positioned between the injector plate 218 and one of the first guide plate 240 and the second guide plate 256.

In some embodiments, sampling the exhaust provided to the sensor 190 through the exhaust sampling flange 302, 402, or 404 results in increased velocity, distribution, and/or swirling of the flow of the exhaust, which may reduce potential fouling of the sensor 190 by particles of the hydrocarbon fluid while maintaining the uniformity index (UI) and the FDI at an inlet of the first oxidation catalyst member 158 (e.g., downstream of the outlet flange aperture 286) at or above certain acceptance criteria. Furthermore, by coupling the exhaust sampling flange 302, 402, or 404 with the mixer body 202 (e.g., being coupled to the mixer body 202 between the inlet flange 272 and the outlet flange 280), measurement of NOₓ concentration downstream of the upstream catalyst member 138 may no longer rely on a separate sampling wheel (e.g., a NOₓ sampling wheel) positioned along the conduit axis 106 upstream of the hydrocarbon mixer 146, thereby shortening an overall axial length for the aftertreatment system 100 for a more compact system design.

While the aftertreatment system 100 has been shown and described in the context of use with a diesel internal combustion engine, the aftertreatment system 100 may be used with other internal combustion engines, such as gasoline internal combustion engines, hybrid internal combustion engines, propane internal combustion engines, dual-fuel internal combustion engines, and other similar internal combustion engines.

### IV. CONFIGURATION OF EXAMPLE EMBODIMENTS

While this specification contains many specific implementation details, these should not be construed as limitations on the scope of what may be claimed but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described as acting in certain combinations and even initially claimed as such, one or more features from a claimed combination can, in some cases, be excised from the combination, and the claimed combination may be directed to a subcombination or variation of a subcombination.

As utilized herein, the terms “substantially,” “generally,” “approximately,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the appended claims.

The term “coupled” and the like, as used herein, mean the joining of two components directly or indirectly to one another. Such joining may be stationary (e.g., permanent) or moveable (e.g., removable or releasable). Such joining may be achieved with the two components or the two components and any additional intermediate components being integrally formed as a single unitary body with one another, with the two components, or with the two components and any additional intermediate components being attached to one another.

The terms “fluidly coupled to” and the like, as used herein, mean the two components or objects have a pathway formed between the two components or objects in which a fluid, such as air, reductant, an air-reductant mixture, hydrocarbon fluid, an air-hydrocarbon fluid mixture, exhaust, may flow, either with or without intervening components or objects. Examples of fluid couplings or configurations for enabling fluid communication may include piping, channels, or any other suitable components for enabling the flow of a fluid from one component or object to another.

It is important to note that the construction and arrangement of the various systems shown in the various example implementations is illustrative only and not restrictive in character. All changes and modifications that come within the spirit and/or scope of the described implementations are desired to be protected. It should be understood that some features may not be necessary, and implementations lacking the various features may be contemplated as within the scope of the disclosure, the scope being defined by the claims that follow. When the language “a portion” is used, the item can include a portion and/or the entire item unless specifically stated to the contrary.

Also, the term “or” is used, in the context of a list of elements, in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

Additionally, the use of ranges of values (e.g., W1 to W2, etc.) herein are inclusive of their maximum values and minimum values (e.g., W1 to W2 includes W1 and includes W2, etc.), unless otherwise indicated. Furthermore, a range of values (e.g., W1 to W2, etc.) does not necessarily require the inclusion of intermediate values within the range of values (e.g., W1 to W2 can include only W1 and W2, etc.), unless otherwise indicated.

What is claimed is:

1. An aftertreatment system comprising:
an introduction conduit; and
a mixer disposed within the introduction conduit, the mixer comprising:
a mixer body centered on a mixer body center axis and configured to receive exhaust and a hydrocarbon fluid, the mixer body having a first end and a second end downstream of the first end,
an exhaust sampling flange coupled to the mixer body at a location adjacent to the second end, the exhaust sampling flange comprising exhaust sampling flange apertures arranged in an array that extends circumferentially around the mixer body center axis,
an outlet flange coupled to the second end at a location downstream of the exhaust sampling flange, the outlet flange comprising an outlet flange aperture configured to facilitate a flow of the exhaust from inside the mixer body, and
an outlet tube coupled to the outlet flange and in fluid communication with at least one of the exhaust sampling flange apertures, wherein a first portion of the outlet tube is coupled to the outlet flange and a second portion of the outlet tube extends from the first portion and into the outlet flange aperture.

2. The aftertreatment system of claim 1, wherein:
the mixer further comprises an inlet flange coupled to the first end, the inlet flange comprising inlet flange apertures, each of the inlet flange apertures configured to facilitate the flow of the exhaust through the inlet flange apertures and around the mixer body;
the outlet flange comprises an opening configured to facilitate the flow of the exhaust between one of the exhaust sampling flange apertures and the outlet tube; and
the second portion of the outlet tube is oriented along an axis perpendicular to the mixer body center axis.

3. The aftertreatment system of claim 2, further comprising a NOₓ sensor coupled to the mixer body and disposed between the exhaust sampling flange and the outlet flange, the NOₓ sensor configured to provide a signal associated with an amount of NOₓ gas in the exhaust flowing through a passageway that extends between one of the exhaust sampling flange apertures and the outlet flange aperture.

4. The aftertreatment system of claim 1, wherein:
the mixer body further comprises a first aperture; and
the mixer further comprises an injector plate coupled to the mixer body adjacent to the first aperture, the injector plate comprising:
an injector plate panel angled away from the mixer body and extending over at least a portion of the first aperture, and
an injection aperture configured to facilitate injection of the hydrocarbon fluid into the mixer body, the injection aperture extending through the injector plate panel.

5. The aftertreatment system of claim 4, wherein the injector plate is offset from a first of the exhaust sampling flange apertures along the mixer body center axis.

6. The aftertreatment system of claim 4, wherein:
the mixer body further comprises a second aperture disposed annularly adjacent to the first aperture; and
the mixer further comprises a guide plate coupled to the mixer body adjacent to the second aperture, the guide plate comprising a guide plate panel angled away from the mixer body and extending over at least a portion of the second aperture.

7. The aftertreatment system of claim 6, wherein the guide plate is aligned with one of the exhaust sampling flange apertures along the mixer body center axis.

8. The aftertreatment system of claim 1, wherein the exhaust sampling flange comprises a first louver adjacent to a first of the exhaust sampling flange apertures, the first louver angled away from the exhaust sampling flange and extending over at least a portion of the first exhaust sampling flange aperture in a first rotational direction around the mixer body center axis.

9. The aftertreatment system of claim 8, wherein the exhaust sampling flange further comprises a second louver adjacent to a second of the exhaust sampling flange apertures, the second louver angled away from the exhaust sampling flange and extending over at least a portion of the second exhaust sampling flange aperture in a second rotational direction opposite the first rotational direction.

10. The aftertreatment system of claim 1, further comprising a catalyst member disposed upstream of the mixer within the introduction conduit, the catalyst member configured to provide the exhaust to the mixer.

11. A mixer for an aftertreatment system, the mixer comprising:
a mixer body centered on a mixer body center axis and configured to receive exhaust and a hydrocarbon fluid, the mixer body comprising:
an upstream end,
a downstream end, and
a first aperture between the upstream end and the downstream end;
an injector plate coupled to the mixer body adjacent to the first aperture;
an exhaust sampling flange coupled to the mixer body between the first aperture and the downstream end, the exhaust sampling flange comprising exhaust sampling flange apertures arranged circumferentially around the mixer body center axis, wherein the injector plate is offset from a first of the exhaust sampling flange apertures along the mixer body center axis;
an outlet flange coupled to the downstream end at a location downstream of the exhaust sampling flange; and
an outlet tube coupled to the outlet flange and in fluid communication with at least one of the exhaust sampling flange apertures, wherein the outlet flange comprises an opening configured to facilitate a flow of the exhaust between one of the exhaust sampling flange apertures and the outlet tube.

12. The mixer of claim 11, further comprising an inlet flange coupled to the upstream end, the inlet flange comprising inlet flange apertures, each of the inlet flange apertures configured to facilitate the flow of the exhaust through the inlet flange apertures and around the mixer body.

13. The mixer of claim 11, wherein the injector plate comprises:
an injector plate panel angled away from the mixer body and extending over at least a portion of the first aperture, and
an injection aperture configured to facilitate injection of the hydrocarbon fluid into the mixer body, the injection aperture extending through the injector plate panel.

14. The mixer of claim 11, wherein:
the mixer body further comprises a second aperture disposed annularly adjacent to the first aperture; and
the mixer further comprises a guide plate coupled to the mixer body adjacent to the second aperture, the guide plate comprising a guide plate panel angled away from the mixer body and extending over at least a portion of the second aperture.

15. The mixer of claim 14, wherein the guide plate is aligned with one of the exhaust sampling flange apertures along the mixer body center axis.

16. The mixer of claim 11, wherein the exhaust sampling flange comprises a first louver adjacent to a first of the exhaust sampling flange apertures, the first louver angled away from the exhaust sampling flange and extending over at least a portion of the first exhaust sampling flange aperture in a first rotational direction around the mixer body center axis.

17. The mixer of claim 16, wherein the exhaust sampling flange further comprises a second louver adjacent to a second of the exhaust sampling flange apertures, the second louver angled away from the exhaust sampling flange and extending over at least a portion of the second exhaust sampling flange aperture in a second rotational direction opposite the first rotational direction.

18. An aftertreatment system comprising:
an introduction conduit; and
a mixer disposed within the introduction conduit, the mixer comprising:
a mixer body centered on a mixer body center axis and configured to receive exhaust and a hydrocarbon fluid, the mixer body having a first end and a second end downstream of the first end,
an exhaust sampling flange coupled to the mixer body at a location between the first end and the second end, the exhaust sampling flange comprising:
exhaust sampling flange apertures arranged in an array that extends circumferentially around the mixer body center axis,
a louver adjacent to a first of the exhaust sampling flange apertures, the louver angled away from the exhaust sampling flange and extending over at least a portion of the first exhaust sampling flange aperture in a rotational direction around the mixer body center axis, and
an outlet flange coupled to the second end at a location downstream of the exhaust sampling flange, the outlet flange comprising an outlet flange aperture configured to facilitate flow of the exhaust from inside the mixer body.

19. The aftertreatment system of claim 18, wherein:
the mixer further comprises an outlet tube coupled to the outlet flange and in fluid communication with at least one of the exhaust sampling flange apertures; and
the outlet tube comprises:
a first portion that is coupled to the outlet flange,
a second portion that extends from the first portion and into the outlet flange aperture, the second portion being oriented along an axis perpendicular to the mixer body center axis, and
an opening configured to facilitate the flow of the exhaust between one of the exhaust sampling flange apertures and the outlet tube.

20. The aftertreatment system of claim 18, further comprising a NOₓ sensor coupled to the mixer body and disposed between the exhaust sampling flange and the outlet flange, the NOₓ sensor configured to provide a signal associated with an amount of NOₓ gas in the exhaust flowing through a passageway that extends between one of the exhaust sampling flange apertures and the outlet flange aperture.
